(19) United States
(12) Patent Application Publication
(10) Pub. No.: US 2026/0221314 A1
(43) Pub. Date: Jul. 30, 2026

(54) INSULATED WIRE, COIL AND ELECTRONIC/ELECTRICAL DEVICE

(71) Applicant: WELL ASCENT ELECTRONIC (GANZHOU) CO., LTD., Ganzhou, Jiangxi (CN)

(72) Inventors: Yuejia ZHU, Ganzhou, Jiangxi (CN); Zuomao ZHU, Ganzhou, Jiangxi (CN)

(21) Appl. No.: 19/149,259

(22) PCT Filed: Mar. 26, 2024
(86) PCT No.: PCT/CN2024/083781

§ 371 Date: Jul. 18, 2025

(30) Foreign Application Priority Data
Jan. 31, 2023 (CN) 202310066654.3
Feb. 2, 2023 (CN) 202310051654.6
Mar. 27, 2023 (CN) 202310307008.1

(51) Int. Cl. H01B 7/02; H01B 7/00; H01B 13/14; H01B 19/04; H01F 5/06

(52) U.S. Cl. CPC H01B 7/0216; H01B 7/0009; H01B 7/0275; H01B 13/145; H01B 13/148; H01B 19/04; H01F 5/06

(57) ABSTRACT

An insulated wire, comprising: a bare conductor wire (11), having a cross-section with a rectangular structure taken along a plane perpendicular to a longitudinal direction of the bare conductor wire (11), wherein adjacent side surfaces of the rectangular structure are connected by rounded corners; and a bonding layer (121) and a thermoplastic resin layer (122) sequentially formed on an outer side of the bare conductor wire (11), wherein a thickness t₁ of the bonding layer (121) at the rounded corner is less than a thickness t₂ of the thermoplastic resin layer (122) at the rounded corner.

### CROSS-REFERENCE TO RELATED APPLICATIONS

The present disclosure claims the benefit of priority to Chinese patent application No. 202310307008.1, filed on Mar. 27, 2023 and entitled “INSULATED WIRE, COIL, AND ELECTRONIC/ELECTRICAL DEVICE”,

to Chinese patent application No. 202310051654.6, filed on Feb. 2, 2023 and entitled “INSULATED WIRE AND METHOD FOR MANUFACTURING SAME, COIL, AND ELECTRONIC/ELECTRICAL DEVICE”, and

to Chinese patent application No. 202310066654.3, filed on Jan. 31, 2023 and entitled “INSULATED WIRE, METHOD AND APPARATUS FOR MANUFACTURING SAME, COIL AND ELECTRONIC/ELECTRICAL DEVICE”, and the entire contents of which are incorporated herein by reference.

### TECHNICAL FIELD

The present disclosure relates to the technical field of insulated wire manufacturing, and particularly relates to an insulated wire, a coil, and an electronic/electrical device.

### BACKGROUND

In recent years, as the reliability requirements for electronic or electrical devices (collectively referred to as electronic/electrical devices) have become increasingly stringent, higher demands have been placed on various properties of insulated wires, such as heat resistance, mechanical properties, chemical properties, and electrical properties, compared to the past.

### SUMMARY

### (I) Object of the Present Disclosure

An object of the present disclosure is to provide an insulated wire, a coil, and an electronic/electrical device.

### (II) Technical Solution

An embodiment of the present disclosure provides an insulated wire including:
a bare conductor wire having a cross-section with a rectangular structure taken along a plane perpendicular to a longitudinal direction of the bare conductor wire, where adjacent side surfaces of the rectangular structure are connected by rounded corners; and
a bonding layer and a thermoplastic resin layer sequentially formed on an outer side of the bare conductor wire, where
a thickness t₁ of the bonding layer at the rounded corner is less than a thickness t₂ of the thermoplastic resin layer at the rounded corner.

Furthermore, radius of curvature of the bare conductor wire at the rounded corner is denoted as R; the radius of curvature of the bonding layer at the rounded corner is denoted as R₁; the radius of curvature of the thermoplastic resin layer at the rounded corner is denoted as R₂; and the R₁, R₂, and R satisfy a relationship represented by the following formula:
R₂≤R+T, where T is defined as total thickness of the bonding layer and the thermoplastic resin layer at the side surface; and
R₁≤R+t₁′, where t₁′ is defined as the thickness of the bonding layer at the side surface.

Furthermore, the t₁ and t₂ satisfy the relationship represented by the following formula:

$$T \leq {t}_{1} + {t}_{2} \leq \sqrt{3.38} T .$$

Furthermore, a value of the R falls in a range of 1/100H to ⅓H, where the H is the thickness of the bare conductor wire.

Furthermore, a width A of the bare conductor wire is in a range of 0.30-25.00 mm, and the thickness H of the bare conductor wire is in a range of 0.20-5.00 mm.

Furthermore, the thickness t₂ of the thermoplastic resin layer at the rounded corner is in a range of 10-1000 μm, and the thickness t₁ of the bonding layer at the rounded corner is in a range of 5-30 μm.

Furthermore, the thickness t₂ of the thermoplastic resin layer at the rounded corner is in a range of 30-500 μm, and the thickness t₁ of the bonding layer at the rounded corner is from 10 μm to 25 μm inclusive.

Furthermore, a material forming the bonding layer includes a bonding agent, which includes a mixed organic solvent, a polyamide-imide resin, and polyether ether ketone (PEEK) nano-powder; a material forming the thermoplastic resin layer includes PEEK resin; and
a material of the bare conductor wire is copper, aluminum, a copper alloy, or an aluminum alloy.

An embodiment of the present disclosure further provides an insulated wire; an insulating layer composed of a bonding layer and a thermoplastic resin layer is formed on an outer side of a bare conductor wire; and a ratio of a maximum coating film thickness to a minimum coating film thickness of the insulating layer is between 1 and 1.3.

Furthermore, the insulating layer includes at least one bonding layer and at least one thermoplastic resin layer, and the bonding layer is disposed between the bare conductor wire and the thermoplastic resin layer.

Furthermore, a cross-section of the bare conductor wire, taken along a plane perpendicular to a longitudinal direction of the bare conductor wire, has a rectangular structure.

Furthermore, the coating film thickness of the insulating layer is in a range of 10-1,000 μm, and the thickness of the bonding layer is in a range of 5-30 μm.

Furthermore, the bare conductor wire includes a plurality of side surfaces, and the difference between the maximum coating film thickness and the minimum coating film thickness of the insulating layer coated on each side surface is less than the difference between the maximum coating film thickness and the minimum coating film thickness of the insulating layer coated on the plurality of side surfaces.

Furthermore, a material forming the bonding layer includes a bonding agent, which includes a mixed organic solvent, a polyamide-imide resin, and PEEK nano-powder; and a material forming the thermoplastic resin layer includes PEEK resin.

Furthermore, a method for manufacturing the above-described insulated wire includes: coating a bonding agent on a surface of a bare conductor wire to form a bonding layer coating the bare conductor wire, thereby obtaining a core wire; and extruding a PEEK resin material on an outer side of the core wire to form a thermoplastic resin layer, thereby obtaining the insulated wire.

An embodiment of the present disclosure further provides an insulated wire, where a bare conductor wire includes a plurality of side surfaces. A first side surface and a second side surface opposite to each other of the bare conductor wire are coated with a thermoplastic resin layer, where the thermoplastic resin layer is formed of a PEEK resin material, and crystallinity of the thermoplastic resin layer coated on the first side surface is a first preset value, and the thermoplastic resin layer coated on the second side surface is in an amorphous state.

Furthermore, the bare conductor wire has a third side surface and a fourth side surface opposite to each other, and the third side surface and the fourth side surface are respectively connected to the first side surface and the second side surface; and the crystallinity of a PEEK resin insulating layer coated on the third side surface and the fourth side surface is a second preset value, where
the first preset value is greater than or equal to the second preset value.

Furthermore, the first preset value falls within a range of 20%-100%, and the second preset value falls within a range of 0%-20%.

Furthermore, a bonding layer is disposed between the bare conductor wire and the PEEK resin insulating layer, and the bonding layer is formed by curing a bonding agent, where the bonding agent includes an organic solvent, a polyamide-imide resin, and PEEK nano-powder.

Furthermore, a material forming the thermoplastic resin layer includes PEEK resin, and a material of the bare conductor wire is copper, aluminum, a copper alloy, or an aluminum alloy.

Furthermore, the bare conductor wire has a width in a range of 0.30-25.00 mm and a thickness in a range of 0.20-5.00 mm.

Furthermore, a method for manufacturing the above-described insulated wire includes:
coating a bonding agent on a surface of a bare conductor wire to form a bonding layer coating the bare conductor wire, thereby obtaining a core wire;
extruding a PEEK resin material on an outer side of the core wire to form a thermoplastic resin layer, thereby obtaining the insulated wire, where the bare conductor wire is a flat polygonal prism, and the bare conductor wire has a first side surface and a second side surface opposite to each other;
cooling the thermoplastic resin layer coated on the first side surface at a first set temperature to obtain crystallinity of a first preset value; and
cooling the thermoplastic resin layer coated on the second side surface at a second set temperature to obtain an amorphous state, where
the first set temperature is higher than the second set temperature, and
preferably, the first set temperature is in a range of 100-200° C. and the second set temperature is ≤50° C.

Furthermore, a manufacturing apparatus for the above-described insulated wire includes:
a heat-retaining chamber, maintaining a first set temperature and configured to cool a first side surface of a target insulated wire so as to obtain crystallinity of a thermoplastic resin layer coated on the first side surface as a first preset value; and
a cooling mechanism, provided at a bottom of the heat-retaining chamber, maintaining a second set temperature and configured to rapidly cool a second side surface of the target insulated wire so as to obtain the thermoplastic resin layer coated on the second side surface in an amorphous state.

The target insulated wire enters the heat-retaining chamber, with the second side surface provided in contact with or adjacent to the cooling mechanism, and the first side surface facing an interior of the heat-retaining chamber, where the bare conductor wire is a flat polygonal prism, and the first side surface and the second side surface are provided opposite to each other.

The first set temperature is higher than the second set temperature.

An embodiment of the present disclosure further provides an insulated wire including:
a bare conductor wire, and
an insulating layer formed on an outer side of the bare conductor wire,
where a ratio of a maximum coating film thickness to a minimum coating film thickness of the insulating layer is between 1 and 1.3.

Furthermore, the bare conductor wire includes a plurality of side surfaces, and the difference between the maximum coating film thickness and the minimum coating film thickness of the insulating layer coated on each side surface is less than the difference between the maximum coating film thickness and the minimum coating film thickness of the insulating layer coated on the plurality of side surfaces.

An embodiment of the present disclosure further provides an insulated wire including:
a bare conductor wire, and
a thermoplastic resin layer formed on an outer side of the bare conductor wire, where
the bare conductor wire is a flat polygonal prism, and the bare conductor wire has a first side surface and a second side surface opposite to each other; crystallinity of the thermoplastic resin layer coated on the first side surface is a first preset value; and the thermoplastic resin layer coated on the second side surface is in an amorphous state.

Furthermore, the bare conductor wire has a third side surface and a fourth side surface opposite to each other, and the third side surface and the fourth side surface are respectively connected to the first side surface and the second side surface; and
the crystallinity of the thermoplastic resin layer coated on the third side surface and the fourth side surface is a second preset value, where
the first preset value is greater than or equal to the second preset value.

An embodiment of the present disclosure further provides a method for manufacturing an insulated wire, including:
coating a bonding agent on a surface of a bare conductor wire to form a bonding layer coating the bare conductor wire, thereby obtaining a core wire;
extruding a PEEK resin material on an outer side of the core wire to form a thermoplastic resin layer, thereby obtaining the insulated wire, where the bare conductor wire is a flat polygonal prism, and the bare conductor wire has a first side surface and a second side surface opposite to each other;
cooling the thermoplastic resin layer coated on the first side surface at a first set temperature to obtain crystallinity of a first preset value; and
cooling the thermoplastic resin layer coated on the second side surface at a second set temperature to obtain an amorphous state, where
the first set temperature is higher than the second set temperature.

An embodiment of the present disclosure further provides a coil including the insulated wire.

An embodiment of the present disclosure further provides an electronic/electrical device including the coil.

### (III) Beneficial Effects

The above technical solutions of the present disclosure have the following beneficial technical effects.

In the present disclosure, by ensuring that the thicknesses of a bonding layer and a thermoplastic resin layer at the rounded corners of a bare conductor wire satisfy a specific relationship, that an insulating coating film thickness on an outer side of the bare conductor wire meets a specific relationship, and that crystallinity of the insulating layer achieves a specified morphology, it is possible to achieve both an increased duty factor of a conductor in the slot and improved insulation performance provided by the coating layer, and make the bending processing characteristics of an insulated wire at a contact surface with electronic components meet requirements, reducing the risk of scratching the surface of the insulated wire in contact with the motor stator.

### BRIEF DESCRIPTION OF DRAWINGS

FIG. 1 is a schematic diagram 1 of a structure of an insulated wire according to an embodiment of the present disclosure.

FIG. 2 is a schematic diagram 2 of a structure of an insulated wire according to an embodiment of the present disclosure.

FIG. 3 is a schematic diagram of a partial structure of an insulated wire 1 manufactured according to the related art of the present disclosure.

FIG. 4 is a schematic diagram of a structure of an insulated wire 2 manufactured according to the related art of the present disclosure.

FIG. 5 is a schematic diagram 3 of a structure of an insulated wire according to an embodiment of the present disclosure.

FIG. 6 is a schematic diagram of a structure of an insulated wire extrusion die from a first perspective according to an embodiment of the present disclosure.

FIG. 7 is a schematic diagram of a structure of an insulated wire extrusion die from a second perspective according to an embodiment of the present disclosure.

FIG. 8 is a schematic diagram of a structure of an insulated wire extrusion die from a third perspective according to an embodiment of the present disclosure.

FIGS. 9a, 9b, and 9c are schematic diagrams of three states of relative positions of wire-through holes of an inner die and an outer die of an extrusion die.

FIG. 10 is a schematic flowchart of a method for manufacturing an insulated wire according to an embodiment of the present disclosure.

FIG. 11 is a schematic diagram of a structure of a manufacturing apparatus for an insulated wire according to an embodiment of the present disclosure.

FIG. 12 is a schematic diagram of a partial structure of a manufacturing apparatus for an insulated wire according to an embodiment of the present disclosure.

FIG. 13 is a schematic diagram of a U-bending test performed on an insulated wire according to an embodiment and a comparative example of the present disclosure.

### NUMERICAL REFERENCES

11. bare conductor wire; 121. bonding layer; 122. thermoplastic resin layer; 1. heat-retaining chamber; 11. first cooler; 121. first heater; 2. power supply; 3. cooling water tank; 31. second heater; 32. third cooler; 4. cooling roller; 5. insulated wire; 6. circulating water tank; 61. second cooler; 62. circulating pump; 7. temperature detector; 8. first cooler; 9. first heater; 10. fan.

### DETAILED DESCRIPTION OF THE EMBODIMENTS

In order to make the objectives, technical solutions, and advantages of the present disclosure more clear and comprehensible, the present disclosure will be further described in detail below with reference to specific embodiments and drawings. It should be understood that these descriptions are merely exemplary and are not intended to limit the scope of the present disclosure. In addition, well-known structures and techniques are omitted in the following description to avoid unnecessarily obscuring the concepts of the present disclosure.

At present, when an insulated wire is processed into a coil and assembled into a stator slot, it is difficult to simultaneously achieve an increased duty factor of a conductor and improved insulation performance provided by a coating layer. In addition, since the surface of the insulated wire adopts an insulating layer with high crystallinity, it is prone to scratch the surface of the insulated wire in contact with the motor stator. In order to address the above problems, the inventors conducted in-depth research and found that: by ensuring that the thicknesses of a bonding layer and a thermoplastic resin layer at the rounded corners of a bare conductor wire satisfy a specific relationship, that the insulating coating film thickness on an outer side of the bare conductor wire meets a specific relationship, and that the crystallinity of the insulating layer achieves a specified morphology, it is possible to achieve both an increased duty factor of a conductor in the slot and improved insulation performance provided by the coating layer, and make the bending processing characteristics of an insulated wire at a contact surface with electronic components meet requirements.

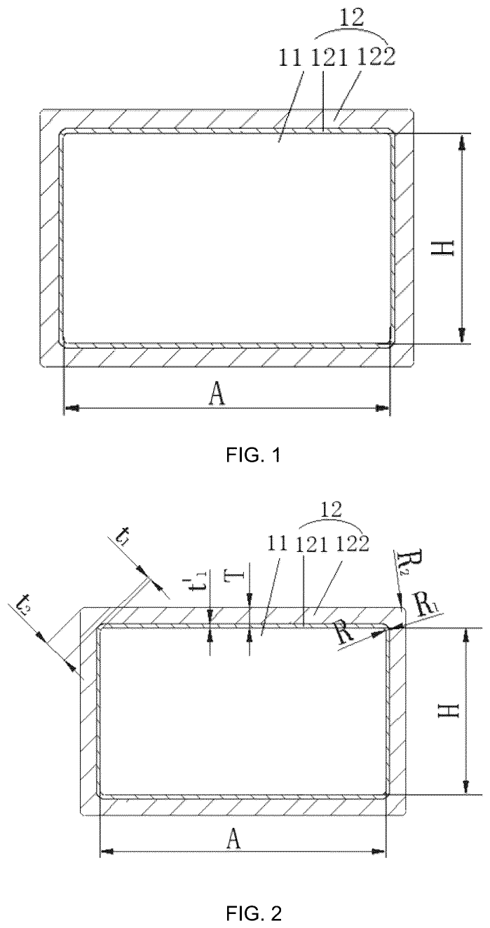

As shown in FIG. 1, an insulated wire provided in an embodiment of the present disclosure includes a bare conductor wire 11 and an insulating layer 12 formed on a surface of the bare conductor wire 11. A cross-section of the bare conductor wire, taken along a plane perpendicular to the longitudinal direction of the bare conductor wire 11, has a rectangular structure, and adjacent side surfaces of the rectangular structure are connected by rounded corners. The insulating layer 12 includes a bonding layer 121 and a thermoplastic resin layer 122 sequentially formed on an outer side of the bare conductor wire 11.

The cross-section of the bare conductor wire, taken along a plane perpendicular to the longitudinal direction of the bare conductor wire, has a rectangular structure. Where the “cross-section” refers to a cross-section orthogonal to the longitudinal direction of the insulated wire. The cross-section of the bare conductor wire can be a circular structure, a rectangular structure, or a polygonal structure, with arcs optionally provided at the corners of the rectangular structure. The bare conductor wire 11 can be made of copper, aluminum, and alloys thereof. For welding considerations, the bare conductor made of low-oxygen copper with an oxygen content of 30 ppm or less, or oxygen-free copper is preferred.

A material forming the bonding layer 121 includes a bonding agent, which includes a mixed organic solvent, a polyamide-imide resin, and PEEK nano-powder; and a material forming the thermoplastic resin layer 122 includes PEEK resin.

The bonding layer 121 is disposed between the bare conductor wire 11 and the thermoplastic resin layer 122. The thermoplastic resin layer 122 can be formed from a PEEK resin material, and the bonding layer 121 is capable of adhering well to both the bare conductor wire material and the thermoplastic resin layer 122, thereby ensuring good adhesion performance of the manufactured insulated wire. Specifically, in embodiments of the present disclosure, the bonding layer 121 can be directly coated on the bare conductor wire 11. Alternatively, a PAI primer layer may first be coated on the bare conductor wire 11 by coating PAI varnish on the conductor followed by baking. However, considering cost factors, it is more preferable that the bonding layer is directly coated on the conductor surface without separately forming the PAI primer layer; and the bonding layer mainly includes PAI resin, which can play a common interlayer insulation role in the prior art, thus eliminating a need to bake a separate PAI primer layer on the bare conductor wire surface.

A material forming the bonding layer 121 includes a bonding agent, which includes a mixed organic solvent, a polyamide-imide resin, and PEEK nano-powder; and a material forming the thermoplastic resin layer includes PEEK resin.

In an exemplary embodiment, components of a bonding agent include an organic solvent, a polyamide-imide (PAI) resin, and PEEK nano-powder, where, by weight, the organic solvent accounts for 50-80 parts, the PAI resin accounts for 20-30 parts, and the PEEK nano-powder accounts for 2-8 parts. For the selection of the organic solvent, types capable of dissolving the PAI resin and dispersing the PEEK nano-powder well within a PAI resin matrix are considered, including nitrogen-containing polar solvents, ether solvents, xylene, or a mixture thereof, where the nitrogen-containing polar solvent is specifically selected from one or more of the following: N-methyl-2-pyrrolidone, N,N-dimethylformamide, N,N-dimethylacetamide, tetramethylurea, and dimethylethyleneurea, and the ether solvent is specifically selected from one or more of the following: diethylene glycol dimethyl ether, triethylene glycol dimethyl ether, tetraethylene glycol dimethyl ether, diethylene glycol, and triethylene glycol. To improve the dispersion of the PEEK nano-powder in the organic solvent, a dispersant can also be added. The dispersant is a surfactant commonly used in this field, preferably selected from one or more of the following: hexadecyltrimethylammonium bromide, alkylphenol-ethylene oxide condensate emulsifier, sodium dodecyl sulfate, sodium dodecyl sulfonate, and sodium dodecylbenzene sulfonate.

The bonding agent has a solid content of 20-40% and a viscosity of 2,500-3,500 cp at 30° C., preferably 3,000 cp.

In an exemplary embodiment, based on considerations of insulation performance and extrusion properties, a thermoplastic resin material forming a thermoplastic resin layer is selected from PEEK resin materials. The PEEK resin materials have a glass transition temperature in a range of 320-360° C., and a melt viscosity of 120-140 pa·s at 400° C., preferably 130 pa·s. The PEEK resin materials within this melt viscosity range exhibit excellent melt extrusion performance, balanced mechanical properties, and processability. By adjusting molecular weight and modifying a resin system, PEEK insulation resin layers with glass transition temperatures and melt index tailored to different conditions can be obtained.

An embodiment of the present disclosure provides an insulated wire including:
a bare conductor wire having a cross-section with a rectangular structure taken along a plane perpendicular to a longitudinal direction of the bare conductor wire, where adjacent side surfaces of the rectangular structure are connected by rounded corners; and
a bonding layer and a thermoplastic resin layer sequentially formed on an outer side of the bare conductor wire, where
a thickness t₁ of the bonding layer at the rounded corner is less than a thickness t₂ of the thermoplastic resin layer at the rounded corner.

In order to improve the duty factor, using of flat wires has been proposed, which requires a smaller radius of curvature at corners of a conductor. However, when the radius of curvature of the corners of the conductor decreases, an insulating coating layer of the insulated wire is prone to cracking caused by bending processing. In order to balance the improvement of the duty factor of the conductor in a stator slot and the enhancement of the insulation performance of a wire, an embodiment of the present disclosure provides an insulated wire, as shown in FIG. 2, including: a bare conductor wire 11 having a cross-section with a rectangular structure taken along a plane perpendicular to a longitudinal direction of the bare conductor wire 11, where adjacent side surfaces of the rectangular structure are connected by rounded corners; and a bonding layer 121 and a thermoplastic resin layer 122 sequentially formed on an outer side of the bare conductor wire 11, where the thickness t₁ of the bonding layer 121 at the rounded corner is less than the thickness t₂ of the thermoplastic resin layer 122 at the rounded corner. The bare conductor wire 11 can be made of copper or a copper alloy; corners of the bare conductor wire 11 are arc-shaped; and the arc is tangent to two adjacent side surfaces of the bare conductor wire 11. The smaller the radius of curvature of the arc, the closer the cross-section of the bare conductor wire 11 is to a rectangular structure, thereby improving the duty factor. A manufactured insulated wire has a flat-shaped bare conductor wire, which allows for a higher slot filling rate of the stator. The bonding layer 121 is disposed between the bare conductor wire 11 and the thermoplastic resin layer 122. Both the bonding layer 121 and the thermoplastic resin layer 122 can be provided at least one layer. The thermoplastic resin layer 122 can be formed from a PEEK resin material. The bonding layer 121 is capable of adhering well to both the bare conductor wire material and the thermoplastic resin layer, ensuring that an insulating coating film of the manufactured insulated wire exhibits good adhesion and is not prone to cracking. The thickness t₁ of the bonding layer 121 at the rounded corner can be provided to be slightly greater than the thickness of the bonding layer 121 at the side surface, and the thickness t₂ of the thermoplastic resin layer 122 at the rounded corner can be provided to be slightly greater than the thickness of the thermoplastic resin layer 122 at the side surface. Furthermore, the thickness t₁ of the bonding layer 121 at the rounded corner is less than the thickness t₂ of the thermoplastic resin layer 122 at the rounded corner. By increasing the insulating coating film thickness at the rounded corner, this can prevent the insulating coating film from cracking caused by bending processes and improve the breakdown voltage and partial discharge inception voltage at the rounded corner.

In some embodiments, radius of curvature of the bare conductor wire 11 at the rounded corner is denoted as R, the radius of curvature of the bonding layer 121 at the rounded corner is denoted as R₁, and the radius of curvature of the thermoplastic resin layer 122 at the rounded corner is denoted as R₂. The R, R₁, and R₂ satisfy Formula 1 and Formula 2 below:

$${R}_{2} \leq R + T ; \qquad ( Formula 1 )$$

where the T is defined as total thickness of the bonding layer 121 and the thermoplastic resin layer 122 at the side surface; and

$${R}_{1} \leq R + {t}_{1}^{′} ; \qquad ( Formula 2 )$$

where the t₁′ is the thickness of the bonding layer 121 at the side surface.

The smaller the radius of curvature R of an arc of the corner of the bare conductor wire 11, the closer a cross-section of the bare conductor wire 11 is to a rectangular structure, thereby improving the duty factor. In order to make the thickness t₁ of the bonding layer 121 at the rounded corner slightly greater than the thickness of the bonding layer 121 at the side surface, the radius of curvature R₁ of the bonding layer 121 at the rounded corner can be provided to be less than or equal to the sum of R and t₁′. Similarly, in order to make the thickness t₂ of the thermoplastic resin layer 122 at the rounded corner slightly greater than the thickness of the thermoplastic resin layer 122 at the side surface, the radius of curvature R₂ of the thermoplastic resin layer 122 at the rounded corner can be provided to be less than or equal to the sum of R and T. Therefore, the insulating coating film thickness at the rounded corner can be increased by appropriately controlling the relationship among R, R₁ and R₂.

In some embodiments, t₁ and t₂ satisfy the relationship represented by the following formula:

$$T \leq {t}_{1} + {t}_{2} \leq \sqrt{3 \text{.38}} T . \qquad ( Formula 3 )$$

An insulating layer can include a bonding layer 121 and a thermoplastic resin layer 122. The thickness t₁ of the bonding layer 121 at a rounded corner can be provided to be slightly greater than the thickness of the bonding layer 121 at a side surface, and the thickness t₂ of the thermoplastic resin layer 122 at the rounded corner can be provided to be slightly greater than the thickness of the thermoplastic resin layer 122 at the side surface, and the thickness t₁ of the bonding layer 121 at the rounded corner and the thickness t₂ of the thermoplastic resin layer 122 rounded corner satisfy the above Formula 3. In this way, the increased insulating coating film thickness at the rounded corner can prevent cracking of the insulating coating film caused by bending processing. However, if a sum of t₂ and t₁ is provided too large, it will easily lead to the following two situations:

(1) if the insulating coating film on the side surfaces where a long side and a short side of the rectangular structure of the bare conductor wire 11 are located is uniform, for example, a maximum insulating coating film thickness at the rounded corner can reach a value of \sqrt{3.38}T; however, if this value is exceeded, the insulating coating film on the side surface where the long side or the short side is located is non-uniform, that is, a thickness deviation of the coating film exceeds 1.3 times a set eccentricity (where the eccentricity is a ratio of the maximum insulating coating film thickness to a minimum insulating coating film thickness), which will lead to fluctuations in insulation performance, resulting in unstable performance indicators such as partial discharge inception voltage (PDIV) and insulation breakdown voltage (BDV), thereby greatly reducing the reliability of a motor; and

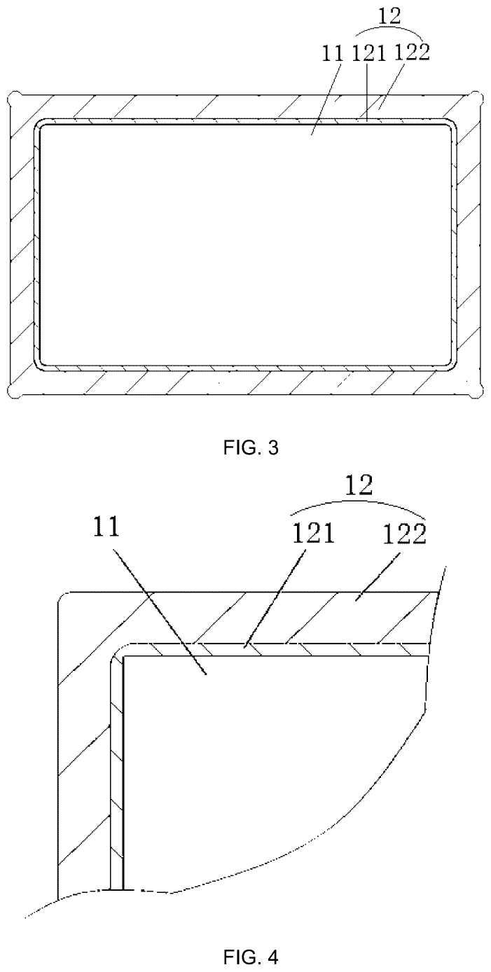

(2) if the insulating coating film at the rounded corner is protruding, as shown in FIG. 3, this irregularity results in a non-uniform coating film of the insulated wire. When the insulated wire is wound, such irregularity prevents the insulated wire from being tightly wound, thereby reducing the slot filling rate of the insulated wire.

If the insulating coating film on the side surfaces where the long side and the short side of the rectangular structure of the bare conductor wire 11 are located is uniform, the 1.3 times eccentricity can be disregarded. A preferred solution is that T, t₁ and t₂ satisfy the relational expression represented by the following Formula 4:

$$T \leq {t}_{1} + {t}_{2} \leq \sqrt{2} T . \qquad ( Formula 4 )$$

In some embodiments, a width A of the bare conductor wire 11 is in a range of 0.30-25.00 mm; and a thickness H of the bare conductor wire 11 is in a range of 0.20-5.00 mm.

If radius of curvature R of the bare conductor wire 11 at the rounded corner is excessively reduced, as shown in FIG. 4, following problems may occur: first, the processing difficulty of the corners of the bare conductor wire 11 increases; and second, the corners of the bare conductor wire 11 become sharper, which is prone to tip effect and more likely to cause tip discharge, thus making the corners more susceptible to breakdown.

In order to solve the above-mentioned problems, in some embodiments, a value of the R falls in a range of 1/100H to ⅓H, where the H is the thickness of the bare conductor wire 11. Preferably, the radius of curvature R of the bare conductor wire 11 at the rounded corner can be set in a range of 1/50H to ⅕H. This allows a cross-section of the bare conductor wire 11 to approximate a rectangular structure, thereby improving a duty factor. It further facilitates the corner processing of the bare conductor wire 11, and helps avoid the tip effect at the corner of the bare conductor wire 11, thus preventing the tip discharge from easily causing breakdown at the corner.

In some embodiments, a thickness t₂ of the thermoplastic resin layer 122 at the rounded corner is in a range of 10-1,000 μm, and a thickness t₁ of the bonding layer 121 at the rounded corner is in a range of 5-30 μm. Preferably, the thickness t₂ of the thermoplastic resin layer 122 at the rounded corner is in a range of 30-750 μm, particularly preferably in a range of 35-500 μm, and especially in a range of 55-250 μm. Specifically, the bonding layer 121 is configured to bond the bare conductor wire and the thermoplastic resin layer, and has the thickness of from 5 μm to 30 μm inclusive; and more preferably, the thickness is from 10 μm to 25 μm inclusive. If the bonding layer is too thin, it may not provide sufficient adhesion to the bare conductor wire and the thermoplastic resin layer. If the bonding layer is too thick, it may make the wire difficult to bend during bending processing.

In some embodiments, a thickness t₂ of the thermoplastic resin layer 122 at the rounded corner is in a range of 30-500 μm; and a thickness t₁ of the bonding layer 121 at the rounded corner is from 10 μm to 25 μm inclusive.

A method for manufacturing the insulated wire according to the embodiments of the present disclosure can specifically include the following steps:
S110, using an enamel coating machine to coat a bonding agent on an outer side of a bare conductor wire 11; during the coating process, an organic solvent in the bonding agent evaporates, and the bonding agent solidifies to form a bonding layer 121 coating the bare conductor wire 11, thereby obtaining a core wire; before entering a screw extruder head, the core wire is preheated at a preheating temperature of 400° C. or above; and during this preheating process, the organic solvent in the bonding agent further evaporates,
where the specific preparation process of the bonding agent is as follows: first, dissolve polyamide-imide resin in an organic solvent by heating and stirring until fully dissolved; then add PEEK nano-powder and stir thoroughly uniformly dispersed; and finally add additional organic solvent to adjust solid content and viscosity, thus obtaining the bonding agent; and
S120, adding PEEK resin material into a charging barrel of the screw extruder and heat the PEEK resin material to a molten state at a temperature of 380-410° C.; then ensuring the PEEK resin material flows uniformly in the charging barrel by rotating a screw of the screw extruder; placing the preheated core wire in front of the screw extruder head; and employing dies of different specifications at the head to uniformly coat a surface of the core wire with the PEEK resin material. After cooling and crystallization, a PEEK thermoplastic resin layer 122 is formed, thereby obtaining an insulated wire structure as shown in FIG. 2.

An embodiment of the present disclosure further provides an insulated wire including: a bare conductor wire and an insulating layer formed on an outer side of the bare conductor wire composed of a bonding layer and a thermoplastic resin layer; and a ratio of a maximum coating film thickness to a minimum coating film thickness of the insulating layer is between 1 and 1.3.

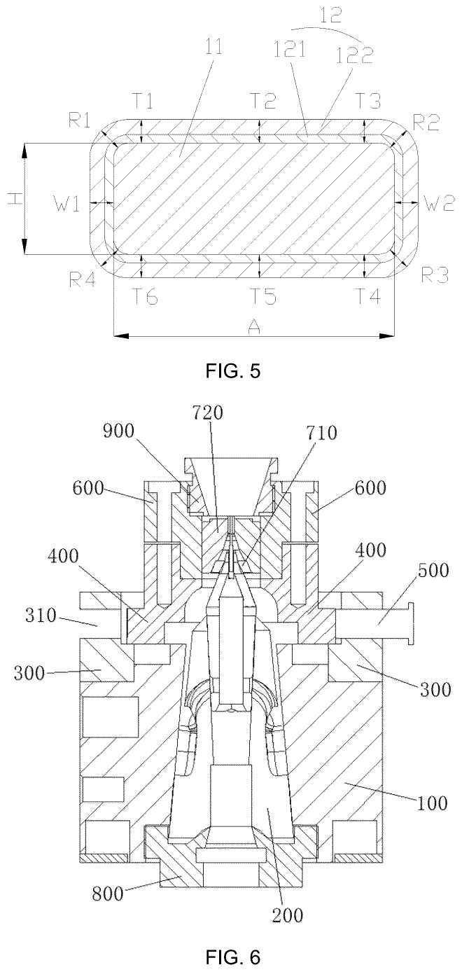

At present, the ratio of the maximum coating film thickness to the minimum coating film thickness of the insulating layer of the insulated wire is 1.3 or greater. Although there is a limitation that a difference between the maximum coating film thickness and the minimum coating film thickness is less than 20 μm, a eccentricity of the coating film (where the ratio of the maximum coating film thickness to the minimum coating film thickness) remains very high. For example, the maximum coating film thickness is 70 μm and the minimum coating film thickness is 50 μm, the eccentricity of the coating film is equal to 1.4. Such non-uniformity in the coating film leads to fluctuations in insulation performance of a wire, resulting in unstable performance indicators such as partial discharge inception voltage (PDIV) and insulation breakdown voltage (BDV), thereby greatly reducing the reliability of a motor. In order to improve the performance indicators such as the partial discharge inception voltage (PDIV) and the insulation breakdown voltage (BDV), and improve the reliability of the motor. An embodiment of the present disclosure provides an insulated wire, as shown in FIG. 5, including: a bare conductor wire 11, and an insulating layer 12 formed on an outer side of the bare conductor wire composed of a bonding layer 121 and a thermoplastic resin layer 122; and a ratio of a maximum coating film thickness to a minimum coating film thickness of the insulating layer 12 is between 1 and 1.3. The “coating film thickness” refers to the thickness of the insulating layer 12 formed on the outer side of the bare conductor wire composed of the bonding layer 121 and the thermoplastic resin layer 122; the bare conductor wire 11 can be made of copper or a copper alloy; the bare conductor wire of a manufactured insulated wire can be configured in a flat shape to make the slot filling rate of a stator be higher; the difference between the maximum coating film thickness and the minimum coating film thickness of the insulating layer 12 can be set to no more than 30 μm, preferably no more than 20 μm; and the ratio of the maximum coating film thickness to the minimum coating film thickness is between 1 and 1.3. The coating film coated in this way is uniform and has a low eccentricity, and through testing, it can be seen that performance indicators such as partial discharge inception voltage (PDIV) and insulation breakdown voltage (BDV) of the insulated wire according to embodiments of the present disclosure can be stably improved, thereby significantly enhancing the reliability of the motor.

In some embodiments, the insulating layer 12 includes at least one bonding layer 121 and at least one thermoplastic resin layer 122, and the bonding layer 121 is disposed between a bare conductor wire and the thermoplastic resin layer 122.

In some embodiments, a coating film thickness of the insulating layer 12 is in a range of 10-1,000 μm, where the thickness of the bonding layer 121 is in a range of 5-30 μm. The coating film thickness of the insulating layer 12 is preferably in a range of 30-750 μm, particularly preferably in a range of 35-500 μm, and especially in a range of 55-250 μm.

Specifically, the bonding layer 121, serving as an adhesive layer, has a thickness of from 5 μm to 30 μm inclusive; and further preferably, the thickness is from 10 μm to 20 μm inclusive. If the adhesive layer is too thin, it may not provide sufficient adhesion to the bare conductor wire and the thermoplastic resin layer 122. If the bonding layer is too thick, it may make the wire difficult to bend during bending processing.

In some embodiments, a thickness of a thermoplastic resin layer 122 is in a range of 10-1,000 μm, preferably in a range of 25-750 μm, particularly preferably in a range of 30-500 μm, and especially in a range of 50-250 μm.

In some embodiments, the bare conductor wire includes a plurality of side surfaces, and a difference between a maximum coating film thickness and a minimum film thickness of the insulating layer coated on each side surface is less than the difference between the maximum coating film thickness and the minimum coating film thickness of the insulating layer coated on the plurality of side surfaces.

By adjusting an extrusion die, it is easier to control uniformity of the coating film on each side surface, and four inner walls of a coating die are flat and smooth. For example, manufactured insulated wires on their long sides in a stator slot, and coating uniformity on such side surfaces are better, enabling both a high duty factor and excellent insulation performance of the insulated wire in a stator slot.

In some embodiments, a method for manufacturing an insulated wire includes the following steps:
S110, using an enamel coating machine to coat a bonding agent on an outer side of a bare conductor wire 11; during the coating process, an organic solvent in the bonding agent evaporates, and the bonding agent solidifies to form a bonding layer 121 coating the bare conductor wire 11, thereby obtaining a core wire; before entering a screw extruder head, the core wire is preheated at a preheating temperature of 400° C. or above; and during this preheating process, the organic solvent in the bonding agent further evaporates;
where the specific preparation process of the bonding agent is as follows: first, dissolve polyamide-imide resin in an organic solvent by heating and stirring until fully dissolved; then add PEEK nano-powder and stir thoroughly uniformly dispersed; and finally add additional organic solvent to adjust solid content and viscosity, thus obtaining the bonding agent; and
S120, adding PEEK resin material into a charging barrel of the screw extruder and heating the PEEK resin material to a molten state at a temperature of 380-410° C.; then ensuring the PEEK resin material flow uniformly in the charging barrel by rotating a screw of the screw extruder; placing the preheated core wire in front of the screw extruder head; and employing dies of different specifications at the head to uniformly coat a surface of the core wire with the PEEK resin material. After cooling and crystallization, a PEEK thermoplastic resin layer 122 is formed, thereby obtaining an insulated wire structure as shown in FIG. 5.

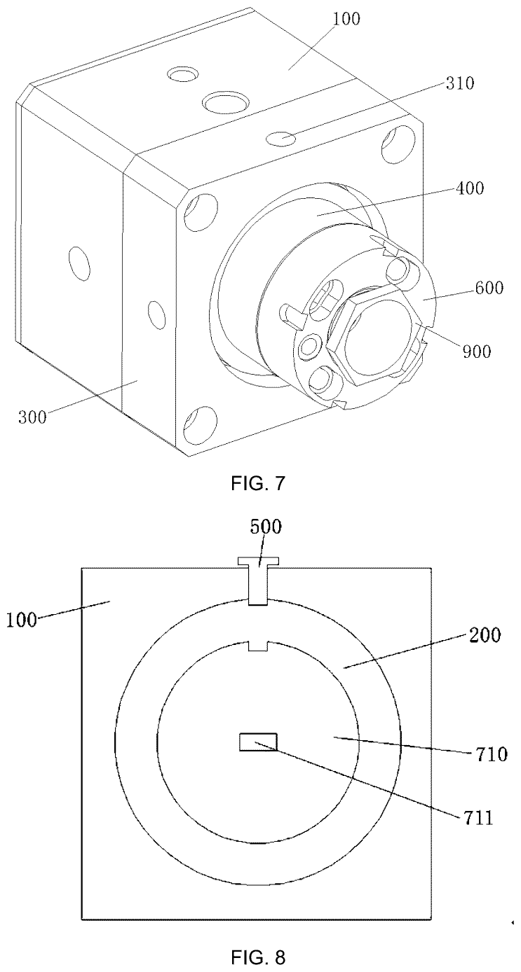

In an embodiment of the present disclosure, an extrusion die of an extruder for manufacturing an insulated wire is shown in FIGS. 6 to 8. By finely adjusting the extrusion die, insulating layers 12 with varying coating film thicknesses can be prepared. During the adjustment, a thickness of a bonding layer 121 changes only slightly, while the thickness of a PEEK insulating resin layer 122 is primarily affected. The extrusion die for the insulated wire may include: a base 100, where the base 100 is provided with a mounting hole; a diverter cone 200, where an end of an inlet of the diverter cone 200 is fixed in the mounting hole; an adjustment unit 300, fixed to an end of the base 100 close to an end of an outlet of the diverter cone 200, where the adjustment unit 300 is provided with at least three side surfaces and is hollow, and at least three side surfaces of the adjustment unit 300 are provided with adjustment holes 310; a first outer die sleeve 400, with one end arranged inside the adjustment unit 300 and the other end provided with a groove configured to fix an outer die 720; and a plurality of adjustment rods 500, where the adjustment rod 500 passes through the adjustment hole 310 and contacts an outer wall of the first outer die sleeve 400, and the adjustment rod 500 is configured to adjust a position of the first outer die sleeve 400 relative to the adjustment unit 300.

In an embodiment of the present disclosure, an extrusion die for an insulated wire adopts a split-type structure, which allows control over an extrusion volume of resin. Through an adjustable outer die 720 structure, when cross-section non-uniformity occurs, the die can be finely adjusted to ensure uniform pressure at a die mouth and a uniform flow rate. This results in a consistent thickness of an insulating layer, stable extrusion, and consistent thickness of extruded PEEK insulating resin layer 122, thereby improving the quality of the insulated wire and reducing wear on an extruder.

In some embodiments, the base 100 and the adjustment unit 300 can be fixedly connected by bolts.

In some embodiments, the base 100 is provided with at least three side surfaces and is hollow; at least three side surfaces of the adjustment unit 300 are provided with adjustment holes 310; the adjustment rod 500 passes through the adjustment hole 310 and contacts an outer wall of the diverter cone 200; and the adjustment rod 500 is configured to adjust a position of the diverter cone 200 relative to the base 100.

In some embodiments, at least three of the adjustment rods 500 pass through the adjustment holes 310 on different side surfaces of the adjustment unit 300.

In some embodiments, the adjustment unit 300 has a polygonal prism structure, with the adjustment holes 310 provided on at least three side surfaces.

In some embodiments, an outer wall of the first outer die sleeve 400 is further provided with a limiting groove matching the adjustment hole 310, and an end of the adjustment rod 500 extending into the adjustment hole 310 is confined within the limiting groove.

In some embodiments, the adjustment rod 500 is a bolt, and an inner wall of the adjustment hole 310 is provided with a thread matching the bolt. An end of the bolt away from a nut passes through the adjustment hole 310 and is confined within the limiting groove.

In some embodiments, a surface of the adjustment rod 500 is provided with a scale mark along an axial direction. In this embodiment, the adjustment rod 500 is provided with a scale mark, and an adjustment dimension can be read through the scale mark, which allows the adjustment dimensions to be read and adjusted accordingly, thereby achieving precise adjustment.

In some embodiments, a plurality of scale marks are provided on a surface of the adjustment rod 500. The scale marks are provided in each direction, facilitating observation from any angle.

In a preferred embodiment, the adjustment unit 300 is a hollow quadrangular prism, and each side surface of the adjustment unit 300 is provided with the adjustment hole 310; four of the bolts pass through four different adjustment holes 310 respectively; and an end of the bolt away from a nut is confined within the limiting groove.

In some embodiments, the extrusion die for the insulated wire can further include a second outer die sleeve 600, with one end arranged inside the groove of the first outer die sleeve 400. The outer die 720 is arranged inside the second outer die sleeve 600; the second outer die sleeve 600 is connected to the outer die 720 via keyed connection; and the second outer die sleeve 600 is rotatably connected to the first outer die sleeve 400.

In some embodiments, an outer wall of the second outer die sleeve 600 can be provided with a slot, and the slot is configured to confine a clamping tool.

When an extruder is operating, if non-uniformity occurs in a cross-section of a PEEK insulating resin layer 122, a die can be finely adjusted to ensure uniform pressure at a die mouth and a uniform flow rate, achieving consistent and stable thickness of the PEEK insulating resin layer 122.

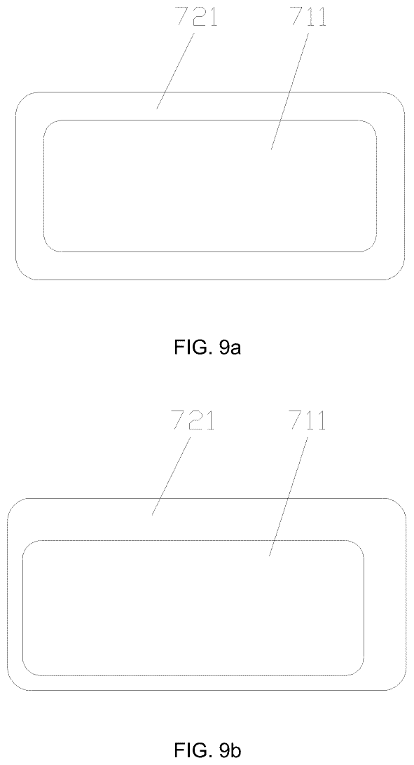

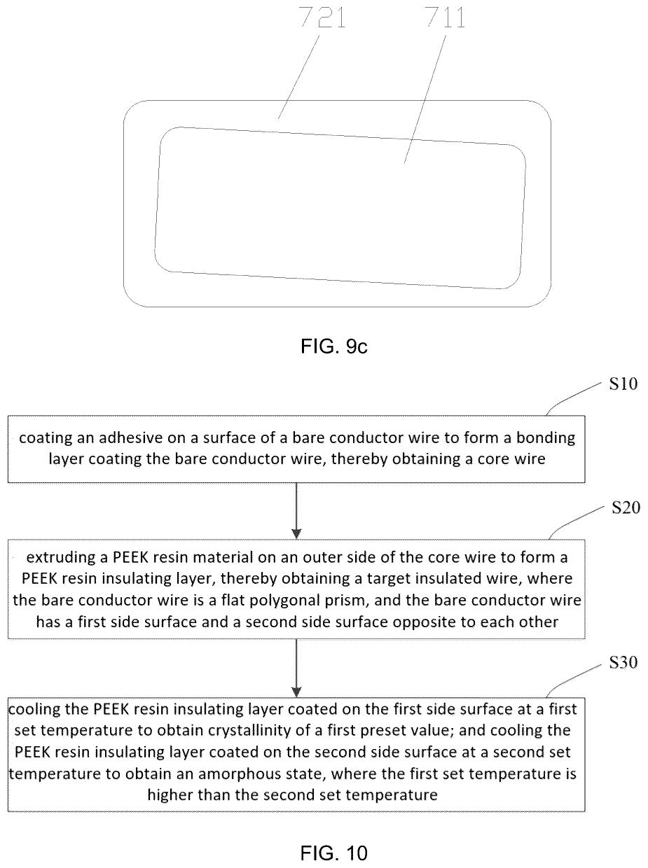

As shown in FIG. 9b, when a first wire-through hole 721 of the outer die 720 and a second wire-through hole 711 of an inner die 710 are positioned asymmetrically, both the first wire-through hole 721 and the second wire-through hole 711 have a rectangular structure. When they are eccentrically arranged, spacing distance between two parallel side surfaces in all directions is inconsistent, resulting in different thicknesses of an insulating layer on each side surface of a rectangular insulated conductor. By adjusting an adjustment rod 500, a position of the first outer die sleeve 400 relative to the adjustment unit 300 can be adjusted, thereby adjusting the outer die 720 relative to the inner die 710 in four directions so that each side surface of the first wire-through hole 721 of the outer die 720 is parallel to each side surface of the second wire-through hole 711 of the inner die 710, and the spacing distance between the two parallel side surfaces of both holes remains substantially consistent. As a result, an extruded PEEK insulating resin layer 122 maintains a consistent thickness on four side surfaces of an insulated wire, that is, an insulating layer has a uniform thickness (as shown in FIG. 9a).

As shown in FIG. 9c, when the outer die 720 rotates relative to the inner die 710 along an axial direction, that is, the first wire-through hole 721 of the outer die 720 and the second wire-through hole of the inner die 710 rotate relative to each other. When four surfaces of the two holes are not completely parallel, spacing distance between two parallel surfaces of the two holes becomes inconsistent. By clamping a clamping tool in a slot provided on the second outer die sleeve 600, the outer die 720 assembly can be rotated to make adjustments.

In some embodiments, the outer die 720 is sleeved within the second outer die sleeve 600; an outer wall of the outer die 720 is provided with a first limiting protrusion; and an inner wall of the second outer die sleeve 600 is provided with a first limiting groove matching the first limiting protrusion. The first limiting protrusion is configured to radially position the outer die 720.

In some embodiments, an end of the second outer die sleeve 600 close to the first outer die sleeve 400 is provided with a protruding portion matching the groove; the outer die 720 is sleeved within the second outer die sleeve 600; and the protruding portion of the second outer die sleeve 600 is disposed in the groove of the first outer die sleeve 400.

In some embodiments, the outer die 720 is a hollow cylindrical structure; and a hollow portion of the first outer die sleeve 400 matches an outer wall of the outer die 720.

In some embodiments, the second outer die sleeve 600 is connected to the first outer die sleeve 400 via a bolt.

In some embodiments, the extrusion die for the insulated wire can further include an inner die 710, where the inner die 710 is provided at an end of an outlet of the diverter cone 200 and is coaxial with the diverter cone 200.

In some embodiments, the inner die 710 is connected to the diverter cone 200 via keyed connection.

In a preferred embodiment, the inner die 710 is sleeved on the diverter cone 200; an inner wall of the diverter cone 200 is provided with a second limiting protrusion; an outer wall of the inner die 710 is provided with a second limiting groove matching the second limiting protrusion; and the second limiting protrusion cooperates with the second limiting groove to restrict arbitrary rotation of the inner die.

In a preferred embodiment, a surface of the inner die 710 is polished to achieve smoothness without any dead corners. This can reduce the flow resistance of PEEK colloid (a state of a PEEK insulating resin layer 122 before formation) can be reduced.

In some embodiments, the extrusion die for the insulated wire can further include a first cover plate 800; the first cover plate 800 is disposed at an inlet of the diverter cone 200; the first cover plate 800 is configured to fix the diverter cone 200 to the base 100; the diverter cone 200 is sleeved within the base 100 and is radially positioned by a screw; and the first cover plate 800 is connected to the base 100 via a thread to achieve axial positioning of the diverter cone 200. The diverter cone 200 is provided with a flow channel. The flow channel adopts a streamlined structure, which allows the PEEK colloid to flow along the flow channel toward a conductor to be coated under very little resistance.

In some embodiments, the extrusion die for the insulated wire can further include a second cover plate 900; the second cover plate 900 is disposed at an end of the second outer die sleeve 600 away from the first outer die sleeve 400; and the second cover plate 900 is configured to fix an outlet of the outer die 720 to the second outer die sleeve 600.

In some embodiments, the second cover plate 900 is threadedly connected to the second outer die sleeve 600 to axially position the outer die 720, and the flow channel of the diverter cone 200 can adopt a streamlined structure. Extruded PEEK colloid flows along a streamlined flow channel, reducing pressure loss and thereby reducing the overall pressure in an extrusion apparatus.

An embodiment of the present disclosure further provides an insulated wire including: a bare conductor wire; the bare conductor wire includes a plurality of side surfaces; a first side surface and a second side surface opposite to each other of the bare conductor wire 11 are coated with a thermoplastic resin layer 122; the thermoplastic resin layer 122 is formed of a PEEK resin material; crystallinity of the thermoplastic resin layer 122 coated on the first side surface is a first preset value; and the thermoplastic resin layer 122 coated on the second side surface is in an amorphous state.

At present, the crystallinity of PEEK in the thermoplastic resin layer coated around a flat copper wire is generally consistent, and a high-crystallinity insulated wire is commonly used. However, a high-crystallinity thermoplastic resin layer is excessively rigid, which can easily scratch a surface of the insulated wire during insertion into a motor slot. For an insulated wire manufactured using extrusion forming technology, an insulating layer is made of a PEEK material. The crystallinity of PEEK has varying effects on the performance of the insulated wire. Insulated wires with high crystallinity exhibit high mechanical strength, while those with low crystallinity exhibit lower stiffness and better flexibility. Insulated wires with superior flexibility have better bending characteristics. For rectangular insulated wires used in motors, a surface that contacts a stator of a motor requires greater flexibility to facilitate bending. In view of this, an embodiment of the present disclosure provides an insulated wire, as shown in FIG. 1, including: a bare conductor wire 11, and a thermoplastic resin layer 122 formed on an outer side of the bare conductor wire 11, where the bare conductor wire 11 is a flat polygonal prism including a plurality of side surfaces; the bare conductor wire 11 has a first side surface and a second side surface opposite to each other; the crystallinity of the thermoplastic resin layer coated on the first side surface is a first preset value; and the thermoplastic resin layer coated on the second side surface is in an amorphous state. In the embodiment of the present disclosure, one side surface of the insulated wire is in the amorphous state, which provides better flexibility and better bending performance, facilitating bending and installation. Therefore, when the amorphous side surface is inserted into a motor slot, it is less likely to scratch the surface of the insulated wire. The side surface of the insulated wire that contacts the stator of the motor has greater flexibility to facilitate bending. However, this side surface has relatively lower mechanical strength. After the motor assembly, the motor will heat up during operation, and due to the characteristics of PEEK wire, when a temperature reaches the crystallization temperature of PEEK, the amorphous portion can further crystallize, thereby enhancing the mechanical strength of the insulated wire. An opposite side surface of the insulated wire has a relatively higher crystallinity, correspondingly providing higher mechanical strength on this side surface to meet the application requirements of the insulated wire.

In some embodiments, the bare conductor wire 11 has a third side surface and a fourth side surface opposite to each other, and the third side surface and the fourth side surface are respectively connected to the first side surface and the second side surface; and crystallinity of a thermoplastic resin layer coated on the third side surface and the fourth side surface is a second preset value, where the first preset value is greater than or equal to the second preset value. A cross-section of the bare conductor wire 11, taken along a plane perpendicular to its longitudinal direction, has a flat structure; and a side surface where a long side is located is defined as a first side surface and a second side, while a side surface where a short side is located is defined as a third side surface and a fourth side surface. Crystallinity of a thermoplastic resin layer coated on the third side surface and the fourth side surface may be the same as or different from that of the thermoplastic resin layer coated on the first side surface. These layers have a certain crystallinity, providing not only a certain degree of mechanical strength but also a certain degree of flexibility to meet the application requirements of the insulated wire.

In some embodiments, the first preset value falls in a range of 20%-100%, and the second preset value falls in a range of 0-20%. Crystallinity of a thermoplastic resin layer coated on a first side surface can be set in a range of 20%-100%, which is relatively high and correspondingly provides high mechanical strength; the crystallinity of the thermoplastic resin layer coated on a third side surface and a fourth side surface can be set in a range of 0-20%, which is relatively low, thereby providing not only a certain degree of mechanical strength but also a certain degree of flexibility to meet the application requirements of the insulated wire.

In some embodiments, a first side surface and a second side surface can be arranged along a width direction of an insulated wire, and a third side surface and a fourth side surface can be arranged along a thickness direction of the insulated wire. By applying different cooling temperatures after a thermoplastic resin layer 122 is formed through extrusion, different degrees of crystallinity can be achieved on the respective side surfaces. When inserted into the motor slot, the insulated wire also comes into contact with a stator in the thickness direction. When bending, the insulated wire is bent along its width direction, and there is no need to bend too much along the thickness direction. Therefore, the crystallinity of the insulated wire in the thickness direction is set between that of the first side surface and the second side surface, which helps to prevent scratches during contact while maintaining sufficient flexibility for bending.

In some embodiments, a thickness of a bonding layer 121 is from 5 μm to 30 μm inclusive; and further preferably, the thickness is from 10 μm and to 20 μm inclusive. If the bonding layer 121 is too thin, it may not provide sufficient adhesion to a bare conductor wire and a thermoplastic resin layer 122. If the bonding layer 121 is too thick, it may make a wire difficult to bend during bending processing.

In some embodiments, a total coating film thickness of a bonding layer 121 and a thermoplastic resin layer 122 is in a range of 10-1,000 μm. The thickness of the thermoplastic resin layer is in a range of 10-1,000 μm, preferably in a range of 25-750 μm, particularly preferably in a range of 30-500 μm, and especially in a range of 50-250 μm.

In some embodiments, a method for manufacturing an insulated wire, as shown in FIG. 10, includes the following steps:
S10, coating a bonding agent on a surface of a bare conductor wire to form a bonding layer coating the bare conductor wire, thereby obtaining a core wire;
S20, extruding a PEEK resin material on an outer side of the core wire to form a thermoplastic resin layer 122, thereby obtaining a target insulated wire, where the bare conductor wire 11 is a flat polygonal prism, and the bare conductor wire 11 has a first side surface and a second side surface opposite to each other; and
S30, cooling the thermoplastic resin layer 122 coated on the first side surface at a first set temperature to obtain crystallinity of a first preset value; and cooling the thermoplastic resin layer 122 coated on the second side surface at a second set temperature to obtain an amorphous state, where the first set temperature is higher than the second set temperature.

In an exemplary embodiment, a first preset value falls in a range of 20%-100%, and a second preset value falls in a range of 0-20%.

In some embodiments, the first set temperature is in a range of 100-200° C., and preferably in a range of 120-150° C.; and the second set temperature is ≤50° C., preferably in a range of 20-35° C. After the thermoplastic resin layer 122 is formed by extrusion to obtain a target insulated wire, the thermoplastic resin layer 122 coated on the first side surface and the second side surface is cooled by controlling a temperature difference, which affects the crystallinity of the thermoplastic resin layer 122 coated on the third side surface and the fourth side surface. Therefore the crystallinity of the thermoplastic resin layer 122 coated on the third side surface and the fourth side surface falls between that of the first side surface and the second side surface.

In some embodiments, crystallinity of a thermoplastic resin layer 122 coated on a first side surface can be set in a range of 20%-100%, which is relatively high and correspondingly provides high mechanical strength; the crystallinity of the thermoplastic resin layer 122 coated on the third side surface and the fourth side surface can be set in a range of 0-20%, which is relatively low, thereby providing not only a certain degree of mechanical strength but also a certain degree of flexibility to meet the application requirements of the insulated wire. The first side surface and the second side surface can be arranged along a width direction of an insulated wire, and the third side surface and the fourth side surface can be arranged along a thickness direction of the insulated wire. By applying different cooling temperatures after a thermoplastic resin layer 122 is formed through extrusion, different degrees of crystallinity can be achieved on the respective side surfaces. When inserted into the motor slot, the insulated wire also comes into contact with a stator in the thickness direction. When bending, the insulated wire is bent along its width direction, and there is no need to bend too much along the thickness direction. Therefore, the crystallinity of the insulated wire in the thickness direction is set between that of the first side surface and the second side surface, which helps to prevent scratches during contact while maintaining sufficient flexibility for bending.

In S30, a PEEK resin material at about 400° C. is extruded and attached to an outer side of a core wire. One side surface is rapidly cooled, for example, by directly immersing the one side surface into a water tank for cooling. A water temperature is set to room temperature, about 25° C., and the one side surface remains in the water for 2-3 min, so that the thermoplastic resin layer 122 coated on the one side surface is in an amorphous state. In order to maintain different degrees of crystallinity of the thermoplastic resin layer on respective side surfaces of the insulated wire, specifically, for example, one side surface can be cooled by a spray cooling method; a temperature of cooling water is a second set temperature, for example, it can be set at room temperature, about 25° C., to ensure that the thermoplastic resin layer 122 coated on the one side surface is formed in an amorphous state; and the remaining side surfaces may be cooled by air cooling. By controlling an air temperature, the air temperature can be adjusted to a first set temperature, for example, the air temperature can be heated to about 135° C., to allow heat exchange with the thermoplastic resin layer to achieve a cooling effect, so that the coated thermoplastic resin layer forms desired crystallinity.

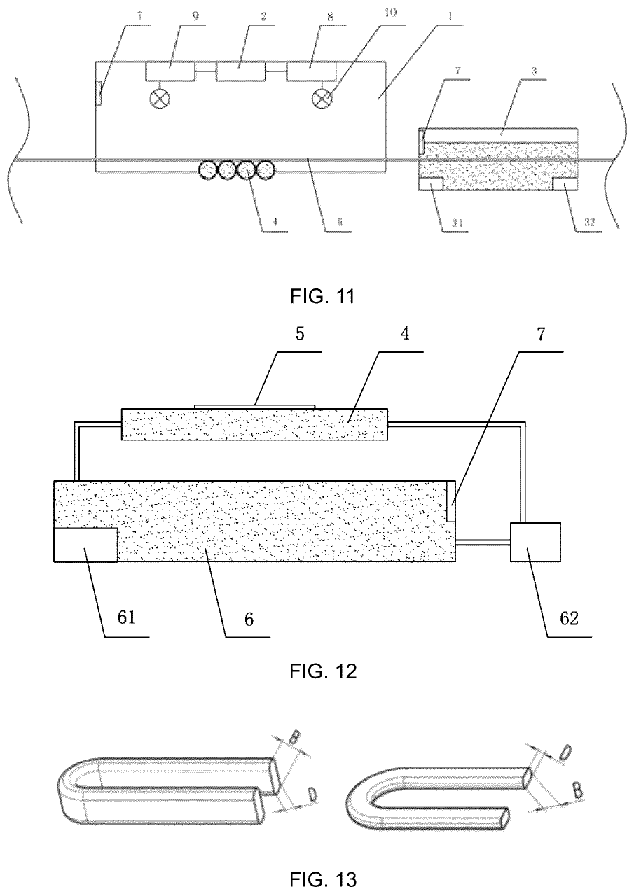

In some embodiments, a manufacturing apparatus for the above-described insulated wire is shown in FIGS. 11-12. The apparatus includes: a heat-retaining chamber 1 and a cooling mechanism. Coat a bonding agent to a surface of a bare conductor wire 11 to form a bonding layer 121 coating the bare conductor wire, thereby obtaining a core wire; and extrude a PEEK resin material on an outer side of the core wire to form a thermoplastic resin layer 122, thereby obtaining a target insulated wire. The heat-retaining chamber 1 maintains a first set temperature and is configured to cool a first side surface of the target insulated wire so as to obtain crystallinity of the thermoplastic resin layer 122 coated on the first side surface as a first preset value. The cooling mechanism, provided at a bottom of the heat-retaining chamber 1, maintains a second set temperature and is configured to rapidly cool a second side surface of the target insulated wire so as to obtain the thermoplastic resin layer 122 coated on the second side surface in an amorphous state. The target insulated wire 5 enters the heat-retaining chamber 1, with the second side surface provided in contact with or adjacent to the cooling mechanism, and the first side surface facing an interior of the heat-retaining chamber 1. The bare conductor wire 11 is a flat polygonal prism, and the first side surface and the second side surface are provided opposite to each other.

In an exemplary embodiment, a first heater 9 and a first cooler 8 are provided in a heat-retaining chamber 1; the first heater 9 and the first cooler 8 are respectively powered by a power supply 2, and the first heater 9 and the first cooler 8 are configured to maintain a constant temperature environment in the heat-retaining chamber 1. A cooling mechanism is provided at the bottom of the heat-retaining chamber 1 and is configured to perform a rapid cooling. When a target insulated wire 5 enters the heat-retaining chamber 1 and passes through the cooling mechanism, one side contacts the cooling mechanism, and the opposite side faces the constant temperature environment in the heat-retaining chamber 1. By setting the constant temperature environment in the heat-retaining chamber 1, polyether ether ketone (PEEK) crystallizes at a preset temperature, so that the crystallinity of PEEK can be controlled. At the same time, by configuring the cooling mechanism, PEEK insulating layer on both sides of the target insulated wire 5 can crystallize under different conditions, so that one side surface can be crystallized and the other side surface remains amorphous. This allows selection of different degrees of crystallinity to meet varying application requirements. For example, when the insulated wire manufactured according to the embodiment of the present disclosure is applied to a motor, a surface in contact with a stator of the motor requires greater flexibility to facilitate bending. In this case, one side surface of the insulated wire can be crystallized and the other side surface remains amorphous, thereby achieving a balance between mechanical strength and flexibility.

In some embodiments, a cooling mechanism includes cooling rollers 4; each cooling roller 4 is a hollow cylinder, where a plurality of the cooling rollers 4 are provided side by side at intervals at a bottom of a heat-retaining chamber 1, and the cooling rollers 4 are in rolling contact with the insulated wire 5; a circulating water tank 6, where circulating water and a second cooler 61 are provided in a cooling water tank, and the second cooler 61 is configured to rapidly cool the circulating water in the circulating water tank 6; and a circulating pump 62, where the circulating pump 62 is connected to both the cooling rollers 4 and the circulating water tank 6, and the circulating pump 62 is powered by a power supply 2 and is configured to provide kinetic energy for the circulating water to circulate between the cooling rollers 4 and the circulating water tank 6. During operating, when the target insulated wire 5 passes over the cooling rollers 4, the rotation of the cooling rollers 4 causes different portions of the target insulated wire 5 to come into contact with the cooling rollers 4 for heat exchange, thereby greatly improving the heat exchange efficiency. Meanwhile, under an action of the circulating water, a temperature of the cooling rollers 4 is constantly maintained at a preset temperature, effectively preventing variations in heat exchange environment (that is, the temperature is initially N at the start of the heat exchange, but it may vary over time as the heat exchange process continues), thus ensuring the stability of product quality.

In some embodiments, a manufacturing apparatus further includes a cooling water tank 3. Cooling water is provided in the cooling water tank 3 along with a second heater 31 and a third cooler 32; the second heater 31 and the third cooler 32 are respectively powered by a power supply 2; and the second heater 31 and the third cooler 32 are configured to maintain the cooling water in the cooling water tank 3 at a constant temperature. After exiting a heat-retaining chamber 1, a target insulated wire 5 enters the cooling water tank 3 and, after being cooled by temperature-controlled cooling water, proceeds to the next processing step. The cooling water tank 3, by means of the second heater 31 and the third cooler 32, can be configured to provide a near-constant temperature cooling environment, which is more conducive to cooling the target insulated wire 5 and helps avoid adverse effects on the performance of a PEEK insulating layer caused by excessive temperature differences.

In some embodiments, temperature detectors 7 are respectively provided in the heat-retaining chamber 1, the cooling water tank 3, and the circulating water tank 6, and are configured to monitor the temperatures in the heat-retaining chamber 1, the cooling water tank 3, and the circulating water tank 6. The manufacturing apparatus further includes a controller. The controller is in communication with the temperature detector 7 provided in the heat-retaining chamber 1 and receives and converts relevant temperature signals; the controller is also in communication with the first heater 9 and the first cooler 8; when the temperature detected in the heat-retaining chamber 1 is lower than a preset threshold, the first heater 9 is activated and the first cooler 8 is deactivated; and when the temperature detected in the heat-retaining chamber 1 is higher than a preset threshold, the first cooler 8 is activated and the first heater 9 is deactivated. The controller is in communication with the temperature detector 7 provided in the cooling water tank 3 and receives and converts the relevant temperature signals; the controller is also in communication with the second heater 31 and the third cooler 32; and when the relevant temperature signal reaches a preset value, the second heater 31 or the third cooler 32 is activated or deactivated under the control of the controller. The controller is in communication with the temperature detector 7 provided in the circulating water tank 6 and receives and converts the relevant temperature signals; the controller is also in communication with the second cooler 61; and when the relevant temperature signal reaches a preset value, the second cooler 61 is activated or deactivated under the control of the controller. Therefore, the constant temperature environments in the heat-retaining chamber 1, the cooling water tank 3, and the circulating water tank 6 are allowed to operate stably.

In some embodiments, the first heater 9 and the first cooler 8 are respectively equipped with a fan 10, and the fan 10 is configured to improve the heat exchange efficiency of the first heater 9 and the first cooler 8 in the heat-retaining chamber 1.

When the manufacturing apparatus for the insulated wire provided in the embodiment of the present disclosure is operating, the relevant devices of the heat-retaining chamber 1, the cooling water tank 3, and the circulating water tank 6 are activated and maintained at preset temperatures. After an target insulated wire 5 is extruded from a die with a formed thermoplastic resin layer 122, the wire proceeds into the heat-retaining chamber 1; upon entering the heat-retaining chamber 1, the target insulated wire 5 passes over the cooling roller 4; as the cooling roller 4 rotates, the circulating water in the cooling roller 4 is mixed more evenly; the second side surface of the target insulated wire 5 is in contact with or adjacent to the surface of the cooling roller 4; driven by the circulating pump 62, the circulating water in the cooling roller 4 begins to circulate and is maintained at a preset second set temperature, for example, about 25° C., by the second cooler 61; at this time, the second side surface forms an amorphous state under the rapid cooling of the cooling roller 4; meanwhile, the thermoplastic resin layer 122 coated on the first side surface of the target insulated wire 5 is cooled and crystallized at a first set temperature in the heat-retaining chamber 1; and for instance, the temperature in the heat-retaining chamber 1 is adjusted to about 135° C., resulting in the crystallinity of the thermoplastic resin layer 122 coated on the first side surface can reach 20%-100%. The thermoplastic resin layer 122 coated on the first side surface and the second side surface are cooled by controlling the temperature difference, which affects the crystallinity of the thermoplastic resin layer 122 coated on the third side surface and the fourth side surface, therefore, the crystallinity of the thermoplastic resin layer 122 coated on the third side surface and the fourth side surface fall between that of the first side surface and the second side surface. After a crystallization process in the heat-retaining chamber 1 is completed, the target insulated wire 5 proceeds into the cooling water tank 3, and in the cooling water tank 3 the target insulated wire undergoes heat exchange with the cooling water. After cooling is completed, the target insulated wire proceeds to the next processing step.

An embodiment of the present disclosure further provides a coil including the insulated wire.

An embodiment of the present disclosure further provides an electronic/electrical device including the coil.

The following specific embodiments serve to illustrate the implementation process of the present disclosure and provide a comprehensive evaluation of the effectiveness.

### Embodiments 1-4

A bare conductor wire 11 having a cross-section configured as a rectangular structure is a flat wire with dimensions of 2.00×3.00 mm. Arcs are provided at the corners of the rectangle. The material of the bare conductor wire 11 is copper, aluminum, or an alloy thereof.
S210, prepare a bonding agent

Dissolve 25 g of modified polyamide-imide resin in 50 ml of a mixed solution of N-methylpyrrolidone (NMP) and xylene (V/V: 1/1) by heating and stirring until fully dissolved; add 5 g of PEEK nano-powder with an average particle size of 50-100 nm and stir thoroughly uniformly dispersed; and finally add additional 25 ml of the mixed solution of the NMP and xylene to adjust solid content and viscosity.
S220, coat a bonding layer 121

Use an enamel coating machine to coat a bonding agent onto a flat copper bare conductor wire 11 with a coating thickness of 10 μm; during the coating process, an organic solvent in the bonding agent evaporates and the bonding agent solidifies to form the bonding layer, thereby obtaining a core wire; and then preheat the core wire to 400° C.
S230, form a PEEK thermoplastic resin layer 122 through extrusion

Provide a PEEK resin material with a glass transition temperature of 340° C.; add the PEEK resin material into a charging barrel of a screw extruder, and heat the PEEK resin material to a molten state at 380° C.; make the PEEK resin material flow uniformly in the charging barrel by rotating a screw of the screw extruder; place the preheated core wire in front of a screw extruder head, from which the PEEK resin material is uniformly coated on a surface of the core wire via an extrusion die; after cooling and crystallization, the PEEK thermoplastic resin layer 122 with a thickness of 160 μm is formed; and by finely adjusting or replacing the extrusion die, flat insulated wires corresponding to Embodiment 1-Embodiment 4 of the present disclosure, as shown in Table 1, can be obtained.

### Comparative Examples 1-2

Flat insulated wires according to Comparative Examples 1-2 as shown in Table 1 are manufactured using the same manufacturing steps as in Embodiments 1-4 of the present disclosure.

The following performance tests are conducted on the insulated wires of the embodiments and comparative examples of the present disclosure.
1. BDV Test (insulation breakdown voltage): strip the insulation from an end of the insulated wire; bend the wire along its wide side over a round rod with a diameter of φ25 mm; place the wire into a container filled with metal steel balls with a thickness of at least 5 mm; and extend the end of the sample far enough to avoid flashover. Apply a test voltage between the conductor and the metal steel balls. The voltage is increased with a voltage ramp rate 500V/s and a leakage current threshold of 5 mA. The test is conducted five times, and an average value is taken as the insulation breakdown voltage evaluation value. The evaluation criteria are as follows:
A+: 16.5 kV or more;
A: 15 kV or more and less than 16.5 kV;
B: 13.5 kV or more and less than 15 kV; and
C: below 13.5 kV.
2. PDIV Test (partial discharge inception voltage): take two insulated wire samples of about 300 mm in length; strip 10-15 mm of the insulating layer from an end of each insulated wire; shape the insulated wire into a model with a straight section with a length of 150 mm; and wind the insulated wires tightly back to back with PI tape. Apply a sinusoidal voltage between the two conductors of the samples according to the following conditions, test and record the test value. Test conditions: room temperature: 25° C.±5° C.; voltage rise rate: 50V/s; frequency: 50 Hz; and partial discharge: 100 pc. The evaluation criteria are as follows (peak value):
A+: 2200 Vp or more;
A: 2000 Vp or more and less than 2200 Vp; and
B: 2000 Vp or less.
3. Adhesion Test

Take insulated wire samples with a length of 300 mm from Embodiments 1-4 and Comparative Examples 1-2 respectively; place the sample between two clamps; that ensure the sample and the clamps are aligned along the same axis; clamp both ends of the sample and stretch by 15% at a rate of 300 mm/min; and check the length of the sample coating film that loses adhesion. In this test method, if the length of the coating film that loses adhesion is less than one time of the wire width, it indicates that the coating film exhibits excellent adhesion.
A+: 0.8 mm or less;
A: 0.8 mm or greater and 1 mm or less;
B: 1 mm or greater and 1.5 mm or less; and
C: 1.5 mm or greater;
4. Flexibility Test

Flexibility test: as shown in FIG. 13, take two straight insulated wires with a length of 400 mm; and bend the two straight insulated wires by 1802° respectively along two directions around a polished test mandrel. The straight section between U-shaped bends should be at least 150 mm. One insulated wire is wound parallel to the axis of the mandrel (with the mandrel diameter being 0.5-2 times the wire thickness), and the other is wound perpendicular to the axis of the mandrel (with the mandrel diameter being 0.5-2 times wire width). In FIG. 13, “B” and “D” represent the wire width and wire thickness of the insulated wires, respectively. The test samples should be heated in a forced ventilation oven at a temperature of 240±5° C. for 30 min. After baking, take out the samples from the oven and allow them to cool to room temperature, and observe them with a 10× magnifying glass.

In this test, after winding parallel and winding perpendicular to the axis of the mandrel, if the surface of the product is smooth and crack-free, the product is recorded as “qualified”; and is the surface cracks are observed, the product is recorded as “fail”.
A+: no cracking when a bending radius is equal to or less than 0.5 times the wire width or wire thickness;
A: no cracking when the bending radius is equal to or greater than 0.5 times and equal to or less than 1.0 time the wire width or wire thickness;
B: no cracking when the bending radius is equal to or greater than 1.0 time and equal to or less than 2.0 times the wire width or wire thickness; and
C: no cracking when the bending radius is equal to or greater than 2.0 times the wire width or wire thickness.

The data obtained through experiments and tests of the insulated wires according to Embodiments 1-4 and Comparative Examples 1-2 of the present disclosure are shown in Table 1:

TABLE 1
Test Data of Insulated Wires

| | | Embodiment | Embodiment | Embodiment | Embodiment | Comparative | Comparative |
|---|---|---|---|---|---|---|---|
| Item | | 1 | 2 | 3 | 4 | Example 1 | Example 2 |
| Conductor Material | | TU1/T1 | TU1/T1 | TU1/T1 | TU1/T1 | TU1/T1 | TU1/T1 |
| Bonding Layer | | 0.01 | 0.01 | 0.01 | 0.01 | 0.01 | 0.01 |
| Thickness (mm) | | | | | | | |
| Thermoplastic Resin | | 0.16 | 0.16 | 0.16 | 0.16 | 0.16 | 0.16 |
| Layer Thickness (mm) | | | | | | | |
| T (mm) | | 0.17 | 0.17 | 0.17 | 0.17 | 0.17 | 0.17 |
| R (mm) | | 0.40 | 0.40 | 0.40 | 0.40 | 0.40 | 0.40 |
| R₁ (mm) | | 0.41 | 0.41 | 0.41 | 0.41 | 0.41 | 0.41 |
| R₂ (mm) | | 0.57 | 0.45 | 0.40 | 0.23 | 0.04 | 0.67 |
| t₁ (mm) | | 0.01 | 0.01 | 0.01 | 0.01 | 0.01 | 0.01 |
| t₂ (mm) | | 0.1600 | 0.2112 | 0.2304 | 0.3025 | 0.3795 | 0.1200 |
| t₁ + t₂ (mm) | | 1T | 1.3T | 2T | 3.38T | 2.29T | 0.76T |
| | | 0.17 | 0.22 | 0.24 | 0.31 | 0.39 | 0.13 |
| Conductor Area (mm²) | | 5.86 | 5.86 | 5.86 | 5.86 | 5.86 | 5.86 |
| Coating Film Area (mm²) | | 6.60 | 6.71 | 6.74 | 6.84 | 6.88 | 6.50 |
| Duty factor | | 88.8% | 87.4% | 87.0% | 85.8% | 85.2% | 90.2% |
| Performance | BDV Test | A | A+ | A+ | A+ | A+ | B |
| Evaluation | PDIV Test | A | A+ | A+ | A+ | A+ | B |
| | Adhesion | A+ | A+ | A+ | A | B | A |
| | Test | | | | | | |
| | Flexibility | A+ | A+ | A+ | A | B | A |
| | Test | | | | | | |

As can be seen from the data in Table 1, for the insulated wires according to the embodiments of the present disclosure, the total thickness T of the bonding layer 121 and the thermoplastic resin layer 122 at the side surface is 170 μm; and when the thickness t₁ of the bonding layer 121 at the rounded corner and the thickness t₂ of the thermoplastic resin layer 122 at the rounded corner satisfy the above-described Formula 3, the partial discharge inception voltage (PDIV) and insulation breakdown voltage (BDV) performance of the insulated wires according to Embodiments 1-4 of the present disclosure are superior and significantly higher than those according to Comparative Examples 1-2. In addition, the adhesion and flexibility tests conducted on the insulated wires according to Embodiments 1-4 also show performance evaluations significantly better than those according to Comparative Examples 1-2. It can be seen from this that increasing the insulating coating film thickness at the rounded corner prevents cracking of the insulating coating film at the rounded corner caused by bending processes, and improves both the breakdown voltage and the partial discharge inception voltage at the rounded corner.

Furthermore, based on the data in Table 1, it can be seen that in Comparative Example 1, the radius of curvature R₂ of the thermoplastic resin layer 122 at the rounded corner is set to be very small, almost approaching a right angle, to increase the total thickness of the thickness t₁ of the bonding layer 121 at the rounded corner and the thickness t₂ of the thermoplastic resin layer 122 at the rounded corner, and the sum of t₁ and t₂ is greater than \sqrt{3.38}T. However, this reduces a duty factor of the insulated wire. The adhesion and flexibility tests performed on such an insulated wire show relatively poor performance evaluations.

In Comparative Example 2, the radius of curvature R₂ of the thermoplastic resin layer 122 at the rounded corner is set to be greater than the sum of R and T, that is, the R₂ is set to be relatively large, which reduces the total thickness of the thickness t₁ of the bonding layer 121 at the rounded corner and the thickness t₂ of the thermoplastic resin layer 122 at the rounded corner, and the sum of t₁ and t₂ is less than T. This correspondingly improves the duty factor of the insulated wire, and the adhesion and flexibility tests performed on such an insulated wire show relatively excellent performance evaluations. However, this configuration tends to compromise the insulation breakdown voltage and the partial discharge inception voltage (PDIV) performance of the insulated wire.

### Embodiments 5-10

A bare conductor wire 11 having a cross-section configured as a rectangular structure is a flat wire with dimensions of 2.00×3.00 mm. Arcs are provided at the corners of the rectangle. The material of the bare conductor wire 11 is copper, aluminum, or an alloy thereof.
S210, prepare a bonding agent

Dissolve 25 g of modified polyamide-imide resin in 50 ml of a mixed solution of N-methylpyrrolidone (NMP) and xylene (V/V: 1/1) by heating and stirring until fully dissolved; add 5 g of PEEK nano-powder with an average particle size of 50-100 nm and stir thoroughly uniformly dispersed; and finally add additional 25 ml of the mixed solution of the NMP and xylene to adjust solid content and viscosity.
S220, coat a bonding layer 121

Use an enamel coating machine to coat a bonding agent onto a flat copper bare conductor wire 11 with a coating thickness of 15 μm; during the coating process, an organic solvent in the bonding agent evaporates and the bonding agent solidifies to form the bonding layer, thereby obtaining a core wire; and then preheat the core wire to 400° C.
S230, form a thermoplastic resin layer 122 through extrusion

Provide a PEEK resin material with a glass transition temperature of 340° C., add the PEEK resin material into a charging barrel of a screw extruder, and heat the PEEK resin material to a molten state at 380° C.; make the PEEK resin material flow uniformly in the charging barrel by rotating a screw of the screw extruder; place the preheated core wire in front of a screw extruder head, from which the PEEK resin material is uniformly coated on a surface of the core wire via an extrusion die; and after cooling and crystallization, the thermoplastic resin layer 122 with a thickness of 85 μm is formed, thereby obtain a flat insulated wire with a total insulating layer thickness of 100 μm. By adjusting an adjustment rod 500 provided in an extrusion die, a position of a first outer die sleeve 400 relative to an adjustment unit 300 can be adjusted, thereby adjusting an outer die 720 relative to an inner die 710 in four directions so that each side surface of a first wire-through hole 721 of the outer die 720 is parallel to each side surface of a second wire-through hole 711 of the inner die 710, and the spacing distance between the two parallel side surfaces of both holes remains substantially consistent (as shown in FIG. 9). As a result, an extruded PEEK insulating resin layer 122 maintains a consistent thickness on four side surfaces of an insulated wire, that is, an insulating layer has a uniform thickness. The thickness of the insulating layer 12 according to Embodiments 1-6 as shown in Table 2 is obtained by performing six times of different fine adjustments on the outer die 720.

### Comparative Example 3

A 100 μm-thick PEEK resin insulating layer 12 is directly coated on a copper bare conductor wire 11 by melt extrusion. Since positions of an inner die and an outer die of an extrusion die are not adjusted, the positions of a first wire-through hole 721 of the outer die 720 and a second wire-through hole 711 of the inner die 710 are shown in FIG. 9b. The PEEK resin material is directly coated on the bare conductor wire 11 through the extrusion die at a head. The insulating layer thickness of the comparative wire according to Comparative Example 1 as shown in Table 2 is obtained. The cross-section of the bare conductor wire 11 is 2.00×3.00 mm.

### Comparative Example 4

A 100 μm-thick PEEK resin insulating layer 12 is directly coated on a copper bare conductor wire 11 by melt extrusion. Since positions of an inner die and an outer die of an extrusion die are not adjusted, the positions of a first wire-through hole 721 of the outer die 720 and a second wire-through hole 711 of the inner die 710 are shown in FIG. 9c. The PEEK resin material is directly coated on the bare conductor wire 11 through the extrusion die at a head. The insulating layer thickness of the comparative wire according to Comparative Example 2 as shown in Table 2 is obtained. The cross-section of the bare conductor wire 11 is 2.00×3.00 mm.

1) The insulating layer of the insulated wire according to the embodiment and comparative example of the present disclosure is measured below.

Cross-section measurement method: cut 30-50 mm wire segments of the insulated wires obtained according to Embodiments 1-6 and Comparative Examples 1-2 as samples; fix them with resin and cut them to an appropriate length; use a grinding machine to polish the cross-section of the wire to obtain a flat and smooth cross-section; and then use a metallographic microscope to measure the thickness of the coating film around the wire.

As shown in FIG. 5, the coating film thickness of an insulating layer in a width A direction of the insulated wire are measured at measurement points: T1, T2, T3, T4, T5, and T6; the coating film thickness of the insulating layer in a thickness H direction of the insulated wire are measured at measurement points: W1 and W2; and the coating film thickness of the insulating layer at an arc of the insulated wire are measured at measurement points: R1, R2, R3, and R4.

Range calculation method: the range of an insulating layer coating film is calculated by subtracting a maximum value from a minimum value among the above 12 measurement points.

Eccentricity calculation method: the eccentricity of the insulating layer coating film is calculated by dividing the maximum value by the minimum value among the above 12 measurement points.

The data of the insulated wires according to Embodiments 5-10 and Comparative Examples 3-4 of the present disclosure obtained through experiments and measurements are shown in Table 2.

TABLE 2
Test Data of Insulated Wires

| | Embodiment | Embodiment | Embodiment | Embodiment | Embodiment | Embodiment | Comparative | Comparative |
|---|---|---|---|---|---|---|---|---|
| Item | 5 | 6 | 7 | 8 | 9 | 10 | Example 3 | Example 4 |
| Nominal | 100 | 100 | 100 | 100 | 100 | 100 | 100 | 100 |
| Thickness of | | | | | | | | |
| Insulating | | | | | | | | |
| Layer/μm | | | | | | | | |
| Eccentricity | 1.05 | 1.1 | 1.15 | 1.2 | 1.25 | 1.3 | 1.4 | 1.5 |
| (a maximum | | | | | | | | |
| value of an | | | | | | | | |
| insulating | | | | | | | | |
| layer coating | | | | | | | | |
| film thickness/ | | | | | | | | |
| a minimum | | | | | | | | |
| value of an | | | | | | | | |
| insulating | | | | | | | | |
| layer coating | | | | | | | | |
| film thickness) | | | | | | | | |
| T1/μm | 98 | 97 | 96 | 93 | 92 | 91 | 85 | 82 |
| T2/μm | 97 | 96 | 95 | 92 | 91 | 89 | 84 | 80 |
| T3/μm | 99 | 100 | 98 | 95 | 94 | 95 | 87 | 84 |
| T4/μm | 100 | 103 | 104 | 105 | 110 | 113 | 114 | 115 |
| T5/μm | 100 | 101 | 102 | 103 | 106 | 110 | 112 | 113 |
| T6/μm | 101 | 104 | 106 | 107 | 112 | 114 | 116 | 117 |
| W1/μm | 96 | 97 | 94 | 93 | 92 | 91 | 86 | 82 |
| W2/μm | 100 | 106 | 105 | 110 | 113 | 115 | 114 | 118 |
| R1/μm | 101 | 99 | 97 | 95 | 96 | 93 | 90 | 85 |
| R2/μm | 100 | 101 | 102 | 98 | 96 | 99 | 93 | 86 |
| R3/μm | 101 | 105 | 106 | 107 | 113 | 116 | 117 | 119 |
| R4/μm | 101 | 106 | 108 | 109 | 114 | 115 | 118 | 120 |
| Measured Range | 5 | 10 | 14 | 18 | 23 | 27 | 34 | 40 |
| (a maximum | | | | | | | | |
| value of an | | | | | | | | |
| insulating | | | | | | | | |
| layer coating | | | | | | | | |
| film thickness | | | | | | | | |
| subtracting | | | | | | | | |
| a minimum | | | | | | | | |
| value of an | | | | | | | | |
| insulating | | | | | | | | |
| layer coating | | | | | | | | |
| film thickness)/μm | | | | | | | | |

As can be seen from the data in Table 2, for the insulated wires according to the embodiments of the present disclosure, the range of the insulating layer coating film according to the embodiments of the present disclosure calculated by subtracting the minimum value of the insulating layer coating film thickness from the maximum value of the insulating layer coating film thickness among the measurement points is ≤30 μm; and the eccentricity (the maximum value of the insulating layer coating film thickness/the minimum value of the insulating layer coating film thickness) of the insulating layer coating film according to the embodiments of the present disclosure is ≤1.3. For the insulated wires according to Comparative Examples 3-4, the range of the insulating layer coating film calculated by subtracting the minimum value of the insulating layer coating film thickness from the maximum value of the insulating layer coating film thickness among the measurement points is greater than 30 μm; and the eccentricity of the insulating layer coating film according to Comparative Examples 3-4 is greater than 1.3. From this comparison, it can be seen that the insulating layers of the insulated wires according to the embodiments of the present disclosure exhibit better uniformity, with small overall range values and uniformly coated coating films. As a result, the performance of the insulated wire can be stabilized, thereby stably improving the electrical performance of windings, inductive products, and the like, and improving the service life of the windings and inductive products.

2) U-bending test: as shown in FIG. 13, take two straight insulated wires with a length of 500 mm; bend the two straight insulated wires by 180±2° respectively around a polished test mandrel; and one insulated wire is wound parallel to the axis of the mandrel (with the mandrel diameter equal to twice a wire thickness), and the other is wound perpendicular to the axis of the mandrel (with the mandrel diameter equal to twice the wire width). In FIG. 13, “B” and “D” represent the wire width and wire thickness of the insulated wires, respectively. In this test, after winding parallel and winding perpendicular to the axis of the mandrel, if the surface of the product is smooth and crack-free, the product is recorded as “qualified”; and is the surface cracks are observed, the product is recorded as “fail”.

3) Insulation breakdown voltage: strip the insulation from an end of the insulated wire; bend the wire along its wide side over a round rod with a diameter of φ25 mm; place the wire into a container filled with metal steel balls with a thickness of at least 5 mm; and extend the end of the sample far enough to avoid flashover. Apply a test voltage between the conductor and the metal steel balls. The voltage is increased with a voltage ramp rate 500V/s and a leakage current threshold of 5 mA. The test is conducted five times, and a difference is taken as the insulation breakdown voltage evaluation value. The evaluation criteria are as follows:
A+: 10 kV or more;
A: 7 kV or more but less than 10 kV;
B: 5 kV or more but less than 7 kV; and
C: below 5 kV.

4) PDIV test (partial discharge inception voltage): take two insulated wire samples of about 300 mm in length; strip 5-10 mm of the insulating layer from an end of each insulated wire; shape the insulated wire into a model with a straight section with a length of 100 mm; and wind the insulated wires tightly back to back with PI tape. Apply a sinusoidal voltage between the two conductors of the samples according to the following conditions, test and record the test value.

Test conditions: room temperature: 25° C.±5° C.; voltage rise rate: 50V/s; frequency: 50 Hz; and partial discharge: 100 pc. The evaluation criteria are as follows (effective value):
A+: 800 V or more;
A: 500 V or more and 800 V or less; and
B: 500V or less.

5) Heat resistance test: after the insulated wire is exposed to a temperature of 240° C. for 100 H, it shall be tested in accordance with the above insulation breakdown voltage; and the test result is required to meet grade B or above.
A+: 10 kV or more;
A: 7 kV or more but less than 10 kV;
B: 5 kV or more but less than 7 kV; and
C: below 5 kV.

TABLE 3
Performance Test Results of Insulated Wires

| | | Embodiment | Embodiment | Embodiment | Embodiment | Embodiment | Embodiment | Comparative | Comparative |
|---|---|---|---|---|---|---|---|---|---|
| Item | | 5 | 6 | 7 | 8 | 9 | 10 | Example 3 | Example 4 |
| Nominal Thickness of | | 100 | 100 | 100 | 100 | 100 | 100 | 100 | 100 |
| Insulating Layer/μm | | | | | | | | | |
| Eccentricity (a | | 1.05 | 1.10 | 1.15 | 1.20 | 1.25 | 1.3 | 1.4 | 1.5 |
| maximum value of an | | | | | | | | | |
| insulating layer coating | | | | | | | | | |
| film thickness/a | | | | | | | | | |
| minimum value of an | | | | | | | | | |
| insulating layer coating | | | | | | | | | |
| film thickness) | | | | | | | | | |
| Performance | U-bending | Qualified | Qualified | Qualified | Qualified | Qualified | Qualified | Qualified | Qualified |
| Evaluation | Test | | | | | | | | |
| | Results | | | | | | | | |
| | BDV Test | A+ | A+ | A+ | A+ | A | A | B | B |
| | Results | | | | | | | | |
| | (kV/rms) | | | | | | | | |
| | PDIV | A+ | A+ | A+ | A+ | A | A | B | B |
| | Test | | | | | | | | |
| | Results | | | | | | | | |
| | (V/rms) | | | | | | | | |
| | Heat | A | A | A | A | A | A | A | A |
| | Resistance | | | | | | | | |
| | Test | | | | | | | | |
| | Results | | | | | | | | |

As can be seen from the data in Table 3, the partial discharge inception voltage (PDIV) and insulation breakdown voltage (BDV) of the insulated wires according to Embodiments 5-10 of the present disclosure are superior and significantly higher than those according to Comparative Examples 3-4. This indicates that the insulating layers of the insulated wires according to the embodiments of the present disclosure have good consistency, the paint film is evenly coated, with uniformly coated coating films and small overall range values, thereby greatly enhancing the reliability motors.

The present disclosure further provides a coil including the insulated wire.

The present disclosure further provides an electronic/electrical device including the coil.

It should be understood that the above-described specific embodiments of the present disclosure are merely intended to illustrate or explain the principles of the present disclosure, and are not intended to limit the scope of the present disclosure. Therefore, any modifications, equivalent substitutions, improvements, or the like, made without departing from the spirit and scope of the present disclosure shall be included within the scope of protection of the present disclosure. Furthermore, the claims attached to the present disclosure are intended to cover all variations and modifications that fall within the scope and boundaries of the attached claims, or equivalents of such scope and boundaries.

### INDUSTRIAL APPLICABILITY

In summary, the present disclosure provides an insulated wire, a coil, and an electronic/electrical device, which can simultaneously achieve an increased duty factor of conductors in the slot and improved insulation performance provided by a coating layer. In addition, the bending processing characteristics meet requirements, reducing the risk of scratching the surface of the insulated wire in contact with the motor stator.

1. An insulated wire, comprising:
a bare conductor wire, having a cross-section with a rectangular structure taken along a plane perpendicular to a longitudinal direction of the bare conductor wire, wherein adjacent side surfaces of the rectangular structure are connected by rounded corners;
and a bonding layer and a thermoplastic resin layer sequentially formed on an outer side of the bare conductor wire, wherein
a thickness t₁ of the bonding layer at the rounded corner is less than a thickness t₂ of the thermoplastic resin layer at the rounded corner.

2. The insulated wire according to claim 1, wherein radius of curvature of the bare conductor wire at the rounded corner is denoted as R, a radius of curvature of the bonding layer at the rounded corner is denoted as R₁, a radius of curvature of the thermoplastic resin layer at the rounded corner is denoted as R₂, and the R₁, R₂ and R satisfy a relationship expressed by a following formula:
$${R}_{2} \leq R + T ,$$
wherein T is defined as total thickness of the bonding layer and the thermoplastic resin layer (122) at the side surface; and
R₁≤R+t₁′, wherein the t₁′ is defined as a thickness of the bonding layer at the side surface.

3. The insulated wire according to claim 2, wherein t₁ and t₂ satisfy a relationship expressed by a following formula: T≤t₁+t₂≤\sqrt{3.38}T.

4. The insulated wire according to claim 2, wherein a value of R falls in a range of 1/100H to ⅓H, wherein
H is a thickness of the bare conductor wire.

5. The insulated wire according to claim 1, wherein a width A of the bare conductor wire is in a range of 0.30-25.00 mm, and a thickness H of the bare conductor wire is in a range of 0.20-5.00 mm.

6. The insulated wire according to claim 1, wherein the thickness t₂ of the thermoplastic resin layer at the rounded corner is in a range of 10-1000 μm, and
the thickness t₁ of the bonding layer at the rounded corner is in a range of 5-30 μm.

7. The insulated wire according to claim 6, wherein the thickness t₂ of the thermoplastic resin layer at the rounded corner is in a range of 30-500 μm, and
the thickness t₁ of the bonding layer at the rounded corner is from 10 μm to 25 μm inclusive.

8. The insulated wire according to claim 1, wherein a material forming the bonding layer comprises a bonding agent; the bonding agent comprises a mixed organic solvent, a polyamide-imide resin, and PEEK nano-powder;
a material forming the thermoplastic resin layer comprises PEEK resin; and
a material of the bare conductor wire is copper, aluminum, a copper alloy, or an aluminum alloy.

9. The insulated wire according to claim 1, wherein an insulating layer composed of the bonding layer and the thermoplastic resin layer is formed on the outer side of the bare conductor wire, and a ratio of a maximum coating film thickness to a minimum coating film thickness of the insulating layer is between 1 and 1.3,
wherein, preferably, the coating film thickness of the insulating layer is in a range of 10-1,000 μm, wherein a thickness of the bonding layer is in a range of 5-30 μm, and
wherein, preferably, the bare conductor wire comprises a plurality of side surfaces, and a difference between the maximum coating film thickness and the minimum coating film thickness of the insulating layer coated on each side surface is less than a difference between the maximum coating film thickness and the minimum coating film thickness of the insulating layer coated on the plurality of side surfaces.

10. The insulated wire according to claim 9, comprising coating a bonding agent on a surface of the bare conductor wire to form the bonding layer coating the bare conductor wire, to obtain a core wire; and
extruding a PEEK resin material on an outer side of the core wire to form the thermoplastic resin layer, to obtain the insulated wire.

11. The insulated wire according to claim 1, wherein the bare conductor wire comprises a plurality of side surfaces; a first side surface and a second side surface opposite to each other of the bare conductor wire are coated with the thermoplastic resin layer; the thermoplastic resin layer is formed of the PEEK resin material; crystallinity of the thermoplastic resin layer coated on the first side surface is a first preset value; and the thermoplastic resin layer coated on the second side surface is in an amorphous state,
wherein, preferably, the bare conductor wire has a third side surface and a fourth side surface opposite to each other; the third side surface and the fourth side surface are respectively connected to the first side surface and the second side surface; and
crystallinity of the thermoplastic resin layer coated on the third side surface and the fourth side surface is a second preset value, wherein
the first preset value is greater than or equal to the second preset value;
more preferably, the first preset value falls in a range of 20%-100%; and
the second preset value falls in a range of 0-20%.

12. The insulated wire according to claim 11, wherein a method for manufacturing the insulated wire comprises:
coating a bonding agent on a surface of the bare conductor wire to form a bonding layer coating the bare conductor wire, to obtain a core wire;
extruding a PEEK resin material on an outer side of a core wire to form the thermoplastic resin layer, to obtain a target insulated wire, wherein the bare conductor wire is a flat polygonal prism, and the conductor bare wire has the first side surface and the second side surface opposite to each other;
cooling the thermoplastic resin layer coated on the first side surface at a first set temperature to obtain the crystallinity of the first preset value; and
cooling the thermoplastic resin layer coated on the second side surface at a second set temperature to obtain the amorphous state, wherein
the first set temperature is higher than the second set temperature; and
preferably, the first set temperature is in a range of 100-200° C. and the second set temperature is ≤50° C.

13. The insulated wire according to claim 11, wherein a manufacturing apparatus for the insulated wire comprises:
a heat-retaining chamber, maintaining a first set temperature and configured to cool the first side surface of a target insulated wire so as to obtain the crystallinity of the thermoplastic resin layer coated on the first side surface as the first preset value; and
a cooling mechanism, provided at a bottom of the heat-retaining chamber, and maintaining a second set temperature and configured to rapidly cool the second side surface of the target insulated wire so as to obtain the thermoplastic resin layer coated on the second side surface in an amorphous state,
wherein the target insulated wire enters the heat-retaining chamber, with the second side surface provided in contact with or adjacent to the cooling mechanism, and the first side surface facing an interior of the heat-retaining chamber; the bare conductor wire is a flat polygonal prism; and the first side surface and the second side surface are provided opposite to each other; and
the first set temperature is higher than the second set temperature.

14. An insulated wire, comprising:
a bare conductor wire, and
an insulating layer formed on an outer side of the bare conductor wire, wherein
a ratio of a maximum coating film thickness to a minimum coating film thickness of the insulating layer is between 1 and 1.3.

15. The insulated wire according to claim 14, wherein the bare conductor wire comprises a plurality of side surfaces, and a difference between the maximum coating film thickness and the minimum coating film thickness of the insulating layer coated on each side surface is less than a difference between the maximum coating film thickness and the minimum coating film thickness of the insulating layer coated on the plurality of side surfaces.

16. An insulated wire, comprising:
a bare conductor wire, and
a thermoplastic resin layer formed on an outer side of the bare conductor wire (11), wherein
the bare conductor wire is a flat polygonal prism; the bare conductor wire has a first side surface and a second side surface opposite to each other; crystallinity of the thermoplastic resin layer coated on the first side surface is a first preset value; and the thermoplastic resin layer coated on the second side surface is in an amorphous state.

17. The insulated wire according to claim 16, wherein the bare conductor wire has a third side surface and a fourth side surface opposite to each other, wherein the third side surface and the fourth side surface are respectively connected to the first side surface and the second side surface;
crystallinity of the thermoplastic resin layer coated on the third side surface and the fourth side surface is a second preset value, wherein
the first preset value is greater than or equal to the second preset value.

18. A manufacturing method for the insulated wire according to claim 16, comprising:
coating a bonding agent on a surface of the bare conductor wire to form a bonding layer coating the bare conductor wire, to obtain a core wire;
extruding a PEEK resin material on an outer side of the core wire to form the thermoplastic resin layer, to obtain a target insulated wire, wherein the bare conductor wire is a flat polygonal prism, and the conductor bare wire has a first side surface and a second side surface opposite to each other; and
cooling the thermoplastic resin layer coated on the first side surface at a first set temperature to obtain a crystallinity of the first preset value; and
cooling the thermoplastic resin layer coated on the second side surface at a second set temperature to obtain an amorphous state, wherein
the first set temperature is higher than the second set temperature.

19. A coil, comprising the insulated wire according to claim 1.

20. An electronic/electrical device, comprising the coil according to claim 19.
